(19) United States
(12) Patent Application Publication
(10) Pub. No.: US 2026/0276548 A1
(43) Pub. Date: Sep. 17, 2026

(54) FLUORESCENCE MICROSCOPE

(71) Applicant: Keyence Corporation, Osaka (JP)

(72) Inventors: Koki KARIYA, Osaka (JP); Tsuyoshi SUENAGA, Osaka (JP)

(73) Assignee: Keyence Corporation, Osaka (JP)

(21) Appl. No.: 19/531,748

(22) Filed: Feb. 6, 2026

(30) Foreign Application Priority Data
Mar. 13, 2025 (JP) 2025-039956

(51) Int. Cl. G01N 21/64; G02B 21/16; G02B 21/36; G06T 11/10

(52) U.S. Cl. CPC G01N 21/6458; G02B 21/16; G02B 21/367; G06T 11/10; G06T 2207/10024; G06T 2207/10056; G06T 2207/10064

(57) ABSTRACT

To facilitate understanding of relevance of images belonging to a group. A fluorescence microscope includes a group image generation section that sets a plurality of pseudo color images generated by an image processing section as images belonging to a first group and sets a non-fluorescence image generated by the image processing section as images belonging to a second group, a specification section that specifies a predetermined group among a plurality of groups, and a display control section that causes a display section to display images belonging to the predetermined group specified by the specification section.

### CROSS-REFERENCE TO RELATED APPLICATIONS

The present application claims foreign priority based on Japanese Patent Application No. 2025-039956, filed March 13, 2025, the contents of which are incorporated herein by reference.

### BACKGROUND OF THE INVENTION

### 1. Technical Field

The present disclosure relates to a fluorescence microscope.

### 2. Description of the Related Art

For example, JP2015-82097A discloses a microscope used for a time-lapse experiment. In the microscope of JP2015-82097A, fluorescence observation of an observation target can be performed by irradiating the observation target with excitation light and detecting fluorescence generated in the observation target, and transmission observation of an observation target can also be performed by irradiating the observation target with transmission illumination and detecting light transmitted through the observation target.

In JP2015-82097A, in a case where a plurality of images is acquired by the fluorescence observation, for each color channel, a list of image files included in that channel is displayed.

Meanwhile, in the case of performing multi-dimensional imaging such as time-lapse imaging, a plurality of images captured at the same position is acquired, but the relevance of the plurality of acquired images is unknown. In this regard, in JP2015-82097A, image files included in a color channel are displayed in a list, but there is a case where it is not necessarily a display form indicating relevance of images, and there is a problem that it is difficult to grasp the relevance of each image in images belonging to a group.

### SUMMARY OF THE INVENTION

The present disclosure has been made in view of such a point, and an object of the present disclosure is to facilitate understanding of relevance of images belonging to a group.

According to one embodiment of the present disclosure, in order to achieve the above object, a fluorescence microscope includes: a stage on which an observation target is placed; an excitation light source configured to irradiate the observation target placed on the stage with excitation light; an illumination light source configured to irradiate the observation target placed on the stage with illumination light; a plurality of absorption filters configured to transmit different wavelengths of fluorescence generated in the observation target irradiated with the excitation light by the excitation light source; a turret in which the plurality of absorption filters is disposed, and configured to switch one absorption filter disposed on an observation optical path; a turret control section configured to sequentially switch, by the turret, one absorption filter disposed on the observation optical path; a detection section configured to sequentially detect fluorescence transmitted through one absorption filter disposed on the observation optical path by a switching operation of the turret controlled by the turret control section, and detect transmission light of the observation target irradiated with illumination light by the illumination light source; an image processing section configured to generate a plurality of pseudo color images on a basis of fluorescence sequentially detected by the detection section and a wavelength band of the absorption filter disposed on the observation optical path and generate a non-fluorescence image on a basis of the transmission light detected by the detection section; a group image generation section configured to set the plurality of pseudo color images generated by the image processing section as images belonging to a first group and set the non-fluorescence image generated by the image processing section as images belonging to a second group; a storage section configured to store the images belonging to the first group and the images belonging to the second group; a specification section configured to specify a predetermined group among a plurality of groups stored in the storage section; and a display control section configured to cause a display section to display images belonging to the predetermined group specified by the specification section.

According to this configuration, the fluorescence generated in the observation target irradiated with the excitation light by the excitation light source is sequentially transmitted to the plurality of absorption filters and sequentially detected by the detection section, whereby the plurality of pseudo color images is generated by the image processing section. Furthermore, the detection section detects transmission light of the observation target irradiated with the illumination light by the illumination light source, whereby a non-fluorescence image such as a phase difference image or a bright field image is generated by the image processing section. As described above, in a case where the plurality of pseudo color images and the non-fluorescence image are generated, the plurality of pseudo color images is stored in the storage section as images belonging to the first group, and the non-fluorescence image is stored in the storage section as images belonging to the second group. When the predetermined group is specified, images belonging to the specified predetermined group are displayed on the display section.

As described above, the plurality of pseudo color images is stored in the storage section as images belonging to the first group, the non-fluorescence image is stored in the storage section as images belonging to the second group, and in a case where the predetermined group is specified, images belonging to the group can be displayed on the display section, so that a user can easily grasp the relevance of each image belonging to the group.

### BRIEF DESCRIPTION OF THE DRAWINGS

FIG. 1 is a diagram illustrating a configuration of a fluorescence microscope according to an embodiment of the present invention;

FIG. 2 is a diagram describing an internal structure of a microscope body and a light source unit;

FIG. 3 is a schematic diagram illustrating an optical path of the fluorescence microscope;

FIG. 4 is a perspective view of a microscope body in which a base housing, a transmitted illumination section, a stage frame, an upper frame, and the like are omitted;

FIG. 5 is a plan view of a filter unit;

FIG. 6 is a perspective view of the filter unit as viewed from above;

FIG. 7 is a perspective view of a single filter cube as viewed from above;

FIG. 8 is a perspective view of the single filter cube as viewed from below;

FIG. 9 is a perspective view of an emission filter unit as viewed from above;

FIG. 10 is a cross-sectional view of a transmitted illumination body;

FIG. 11A is a diagram illustrating an example of an image that can be acquired by the fluorescence microscope in a case where a filter wheel is not used;

FIG. 11B is a diagram illustrating an example of an image that can be acquired by the fluorescence microscope in a case where the filter wheel is used;

FIG. 11C is a diagram illustrating an example of an image that can be acquired by the fluorescence microscope according to another example in a case where the filter wheel is used;

FIG. 12 is a diagram illustrating an example of a setting user interface screen;

FIG. 13 is a diagram illustrating an example of a setting screen for multidimensional imaging;

FIG. 14 is a diagram illustrating a structure of a group file;

FIG. 15A is a diagram describing an example of a group image;

FIG. 15B is a diagram describing another example of the group image;

FIG. 16 is a flowchart illustrating an example of a process of determining a number-of-groups;

FIG. 17 is a diagram illustrating an example of a channel information list;

FIG. 18 is a diagram illustrating an example of a group display screen for displaying images belonging to a predetermined group;

FIG. 19 is a flowchart illustrating an example of a process of generating a group display screen;

FIG. 20 is a diagram corresponding to FIG. 19 in a case where a composite image is displayed;

FIG. 21 is a diagram corresponding to FIG. 18 in a case where images of a plurality of channels are displayed;

FIG. 22 is a diagram corresponding to FIG. 18 in a case where a bright field image or a phase difference image is displayed;

FIG. 23 is a diagram illustrating another display example of images belonging to the predetermined group;

FIG. 24 is a diagram illustrating still another display example of images belonging to the predetermined group;

FIG. 25 is a flowchart illustrating an example of a process of stitching a plurality of images;

FIG. 26 is a flowchart illustrating an example of provisional reference plane decision processing for each channel; and

FIG. 27 is a diagram describing an example of processing of deciding a reference plane.

### DETAILED DESCRIPTION

Hereinafter, embodiments of the present invention will be described in detail with reference to the drawings. Note that the following description of preferred embodiments is merely exemplary in nature and is not intended to limit the present invention, its application, or its use. For example, the relative size and positional relationship of each member illustrated in the drawings are for describing one embodiment, and do not limit the present invention.

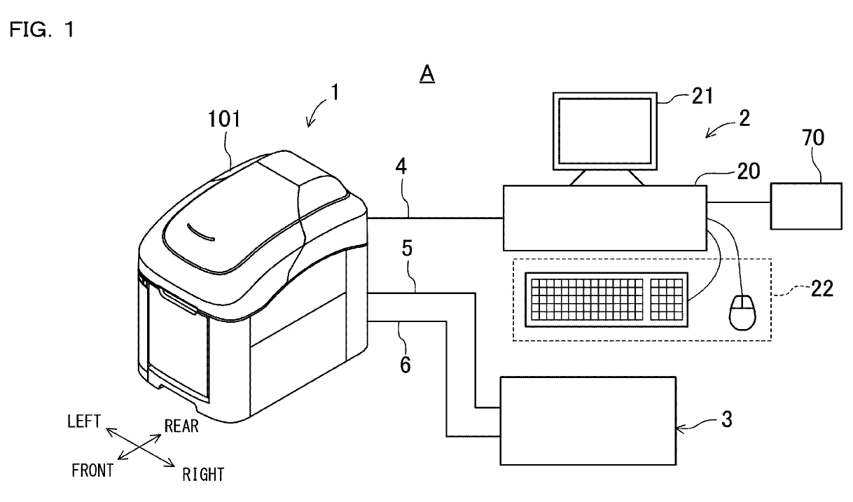

FIG. 1 is a diagram illustrating a configuration of a fluorescence microscope A according to an embodiment of the present invention. The fluorescence microscope A can perform fluorescence observation of an observation target. Furthermore, in addition to the fluorescence observation, the fluorescence microscope A can perform bright field observation, dark field observation, phase difference observation, differential interference observation, and the like using light transmitted through the observation target. In the following description, the bright field observation, the dark field observation, the phase difference observation, and the differential interference observation using light transmitted through the observation target are collectively referred to as transmission observation.

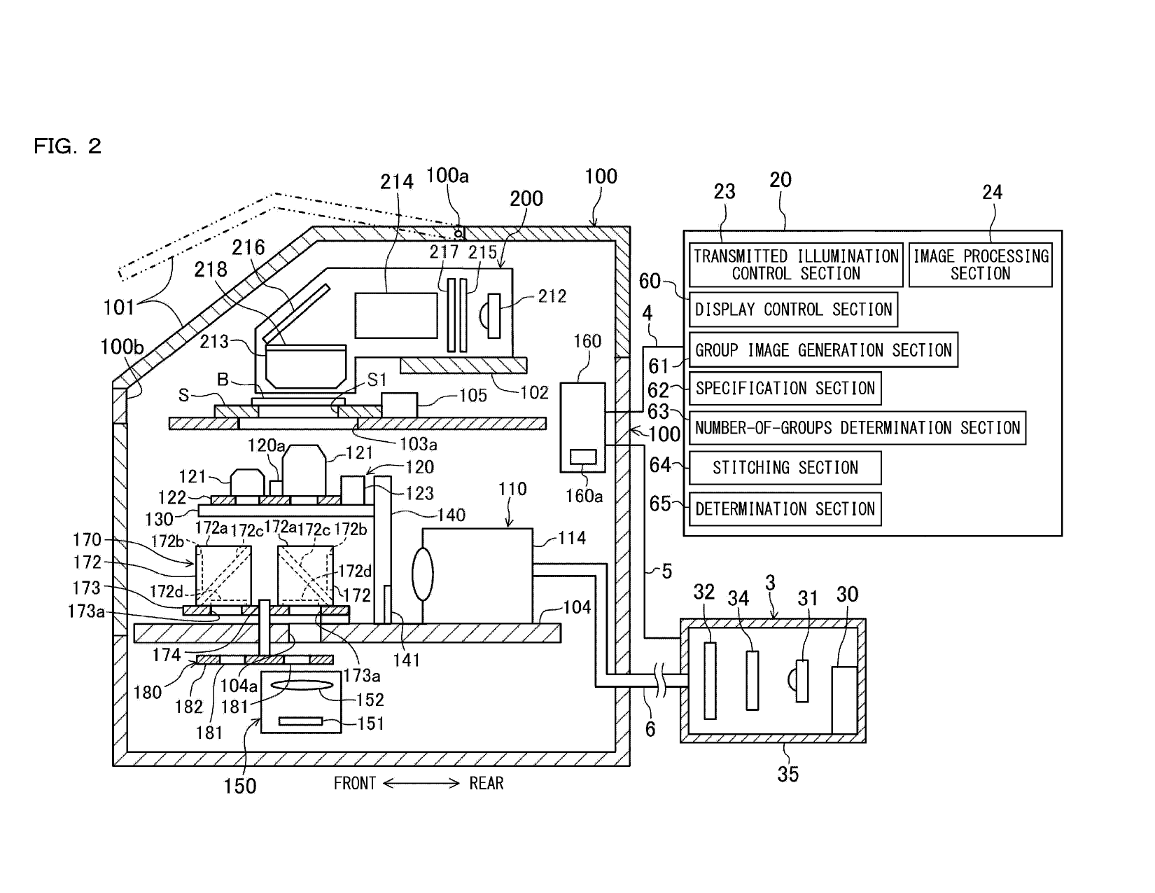

The observation target B (schematically illustrated in FIG. 2) observed in the present embodiment is a biological specimen or the like including various proteins. In a case where fluorescence observation of a biological specimen is performed, a fluorescent reagent that binds to a specific protein is used for the observation target B. Examples of the fluorescent reagent include green fluorescent protein (GFP), TexasRed, and diamidinophenylindole (DAPI), but fluorescence observation using a fluorescent reagent other than these is also possible.

For example, the GFP absorbs light having a wavelength of around 490 nm and emits light having a wavelength of around 510 nm. The TexasRed absorbs light having a wavelength of around 596 nm and emits light having a wavelength of around 620 nm. The DAPI absorbs light having a wavelength of around 345 nm and emits light having a wavelength of around 455 nm. As described above, the wavelength of light absorbed by the fluorescent reagent is different, and the wavelength of light emitted is also different.

The fluorescence microscope A includes, for example, a microscope body 1, an electronic computer 2, and a light source unit 3. Therefore, the fluorescence microscope A can also be referred to as a fluorescence microscope system or a fluorescence microscope device. The microscope body 1 and the electronic computer 2 are connected by a first wiring 4 and can communicate with each other. The microscope body 1 and the light source unit 3 are connected by a second wiring 5 and can communicate with each other. Moreover, the microscope body 1 and the light source unit 3 are connected by a fiber cable (transmission member) 6, and excitation light generated by the light source unit 3 can be transmitted to the microscope body 1 via the fiber cable 6 as described later. As described above, the fluorescence microscope A also includes the first wiring 4, the second wiring 5, and the fiber cable 6. As the first wiring 4, for example, a local area network (LAN) cable, a universal serial bus (USB) cable, or the like can be used. As the second wiring 5, for example, a cable in which a power supply line and a signal line are integrated can be used.

Note that the electronic computer 2 may be omitted, and the function of the electronic computer 2 may be incorporated in the microscope body 1. Furthermore, the light source unit 3 may be omitted, and the function of the light source unit 3 may be incorporated in the microscope body 1. Furthermore, the microscope body 1 may be configured by a single device.

As illustrated in FIG. 2, the light source unit 3 includes a power supply device 30, an illumination section 31, an excitation filter 32 that selectively transmits a wavelength of excitation light emitted from the illumination section 31, a light shielding mechanism 34, and an excitation illumination housing 35. The power supply device 30, the illumination section 31, the excitation filter 32, and the light shielding mechanism 34 are accommodated in the excitation illumination housing 35. A commercial power supply is connected to the power supply device 30, and power is supplied from the commercial power supply. The power supply device 30 supplies power supplied from the commercial power supply to the illumination section 31 and also supplies the power to the microscope body 1 via the second wiring 5. A power supply mode is not limited to the above-described mode, and the commercial power supply may be connected to the microscope body 1.

The illumination section 31 is a part that generates light used for observation, and includes, for example, a white light emitting diode (LED) or the like. The illumination section 31 may be configured with a light source other than a white light emitting diode (LED), and may be, for example, another light source such as a metal halide lamp, a mercury lamp, or a xenon lamp. The light emitted from the illumination section 31 is excitation light used at the time of fluorescence observation.

The light shielding mechanism 34 is, for example, a mechanical shutter. The light shielding mechanism 34 is disposed so as to be located on an optical path of light emitted from the illumination section 31. In a case where the light shielding mechanism 34 is in the non-light shielding state, the light emitted from the illumination section 31 passes through the light shielding mechanism 34 and enters the excitation filter 32. On the other hand, in a case where the light shielding mechanism 34 is in a light shielding state, the light emitted from the illumination section 31 is blocked and is not incident on the excitation filter 32. The light shielding mechanism 34 may include a light modulation element capable of switching between passage and blocking of light emitted from the illumination section 31. The light shielding mechanism 34 is in a non-light shielding state in a case where fluorescence observation of the observation target B is performed, and is in a light shielding state in a case where fluorescence observation of the observation target B is not performed.

The excitation filter 32 includes a plurality of excitation filters corresponding to the types of fluorescent reagents. When the light emitted from the illumination section 31 enters the excitation filter 32, the wavelength of the excitation light is selectively transmitted and emitted to one end portion of the fiber cable 6. The excitation light incident on one end portion of the fiber cable 6 is transmitted to the other end portion of the fiber cable 6 and is incident on the microscope body 1. The fiber cable 6 may be either a glass fiber or a quartz fiber. Furthermore, a liquid light guide or the like can also be used as the transmission member. Since the light source unit 3 is separated from the microscope body 1 in this manner, it is not necessary to provide the illumination section 31 that easily generates heat in the microscope body 1. Therefore, a countermeasure for heat dissipation of the microscope body 1 becomes unnecessary, and it is possible to achieve both irradiation of strong excitation light and miniaturization of the microscope body 1.

The microscope body 1 includes a base housing 100. Since the base housing 100 is separated from the excitation illumination housing 35, it can be installed separately from the excitation illumination housing 35. In the description of this embodiment, as illustrated in a front-rear direction and a left-right direction in FIG. 1, a side facing an observer (user) who performs observation using the microscope body 1 is referred to as a front side of the microscope body 1, a side opposite to the side facing the observer is referred to as a rear side of the microscope body 1, a right side as viewed from the observer is simply referred to as a right side, and a left side as viewed from the observer is simply referred to as a left side. The definitions of these directions are for convenience of description of the embodiment, and do not limit the present invention.

An opening 100b is formed in an upper portion of the base housing 100. An upper surface lid 101 for opening and closing the opening 100b is provided in the upper portion of the base housing 100. The rear side of the upper surface lid 101 is connected to the upper portion of the base housing 100 via a shaft 100a extending in the left-right direction. As indicated by a virtual line, the opening 100b of the base housing 100 can be opened by rotating the upper surface lid 101 upward around the shaft 100a. On the other hand, by closing the opening 100b of the base housing 100 as indicated by the solid line, the inside of the base housing 100 can be made a dark room.

The base housing 100 of the microscope body 1 includes an upper frame 102, a stage frame 103, and a lower frame 104. The upper frame 102 is provided in an upper portion inside the base housing 100. The stage frame 103 is provided below the upper frame 102 inside the base housing 100. The lower frame 104 is provided below the stage frame 103 inside the base housing 100. The upper frame 102, the stage frame 103, and the lower frame 104 extend horizontally and are in parallel positional relationship with each other. Openings 103a and 104a through which light used for observation of the observation target B passes are formed in the stage frame 103 and the lower frame 104, respectively. The opening 103a of the stage frame 103 and the opening 104a of the lower frame 104 are formed such that their centers are located on the same straight line extending in an up and down direction.

The microscope body 1 includes a stage S on which the observation target B is placed. The stage S is accommodated in the base housing 100 and is placed on the upper surface of the stage frame 103. The stage S also has an opening S1 through which light used for observation of the observation target B passes. The opening S1 of the stage S is disposed so as to overlap the opening 103a of the stage frame 103 in plan view. Moreover, an XY driving device 105 that drives the stage S in an X direction and a Y direction orthogonal to each other is attached to the upper surface of the stage frame 103. The X direction is the left-right direction, and the Y direction is the front-rear direction. That is, the XY driving device 105 is a device for moving the stage S in a horizontal direction.

The microscope body 1 includes an illumination module (illumination section) 110 that irradiates the observation target B placed on the stage S with excitation light as observation light. The illumination module 110 is accommodated in the base housing 100 and attached to the lower frame 104. In the present embodiment, the illumination module 110 is provided behind the optical module 120 described later. Note that the illumination module 110 may be provided below the optical module 120.

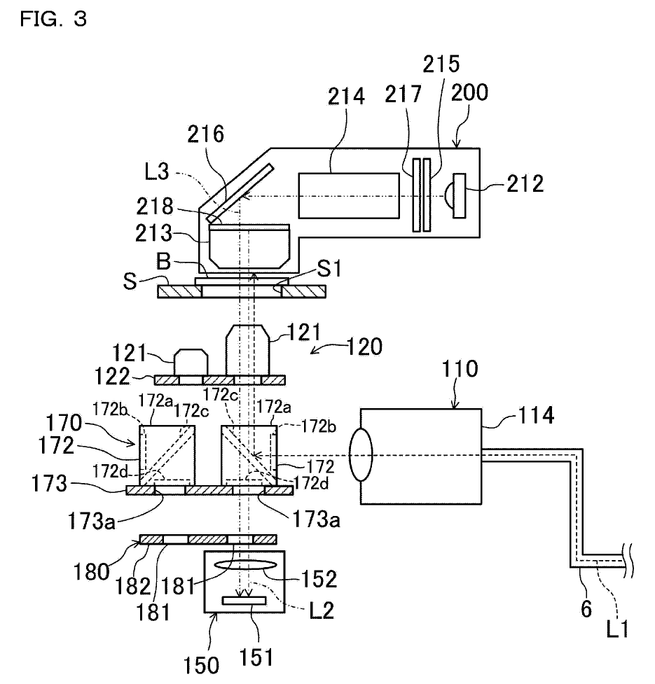

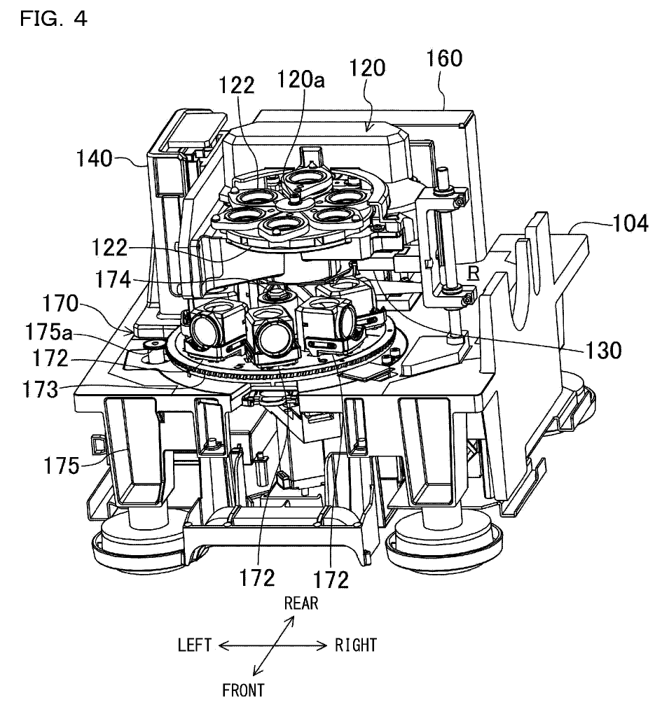

As illustrated in FIG. 3, the other end (the end on the side from which the excitation light is emitted) of the fiber cable 6 is connected to the rear side of the illumination module 110. In FIG. 3, a broken line L1 indicates an optical path of the excitation light.

The illumination module 110 is an excitation illumination section that irradiates the observation target B placed on the stage S with excitation light for fluorescence observation, and includes a module case 114. The other end portion of the fiber cable 6 is connected to the lower portion on the rear side of the module case 114. Furthermore, an optical modulation element that modulates the excitation light emitted from the fiber cable 6 may be provided in the module case 114.

The excitation light emitted from the module case 114 is emitted forward from the front side of the module case 114. The optical path of the excitation light emitted from the module case 114 is along the X direction.

The microscope body 1 includes an optical module 120, a Z-plate 130, and a Z-drive module 140. The optical module 120, the Z-plate 130, and the Z-drive module 140 are accommodated in the base housing 100. The optical module 120 is disposed on the optical path L1 of the excitation light emitted from the illumination module 110, collects the excitation light emitted from the illumination module 110, guides the excitation light to the observation target B, and collects the fluorescence generated in the observation target B. In FIG. 3, an optical path of fluorescence generated in the observation target B is indicated by a one-dot chain line L2. The optical module 120 is provided in front of the illumination module 110.

The Z-plate 130 is a member connected to the optical module 120, is provided between the stage frame 103 and the lower frame 104, and extends along the XY plane.

The optical module 120 includes a plurality of objective lenses 121, a revolver 122, and a revolver drive device 123. The number of the objective lenses 121 is not particularly limited, and may be any number. The objective lens 121 is disposed below the stage S, and is a member for collecting fluorescence generated from the observation target B by being irradiated with excitation light from the illumination module 110 at the time of fluorescence observation. Furthermore, at the time of transmission observation, the objective lens 121 collects the transmitted light emitted from the transmitted illumination section 200 to be described later and transmitted through the observation target B. The objective lens 121 is an observation optical system. The optical axis of each objective lens 121 is along the Z direction.

The revolver 122 is provided on the Z-plate 130 and is supported by the Z-plate 130 so as to be rotatable about a revolver shaft 120a extending in the vertical direction (Z direction). The plurality of objective lenses 121 is detachably attached to the revolver 122 in a state of being disposed so as to surround the revolver shaft 120a.

The revolver drive device 123 is attached to the upper surface of the Z-plate 130. By rotating the revolver 122 around the revolver shaft 120a by the revolver drive device 123, a desired one objective lens 121 among the plurality of objective lenses 121 is disposed immediately below the opening 103a of the stage frame 103, and the optical axis of the objective lens 121 is disposed on the optical path L2 of the fluorescence generated in the observation target B and the optical path L3 of the transmitted light. In this manner, the objective lens 121 used for observation can be switched by the revolver drive device 123. That is, the revolver 122 is a member in which the plurality of objective lenses 121 is disposed to be rotatable about the revolver shaft 120a and that switches the objective lens 121 disposed on the observation optical path.

The Z-drive module 140 is provided in a portion on the left side and the rear side of the lower frame 104. A lower portion of the Z-drive module 140 is attached to the upper surface of the lower frame 104, and the Z-drive module 140 has a shape protruding upward from the upper surface of the lower frame 104.

The Z-drive module 140 is connected to the Z-plate 130 and moves the objective lens 121, the revolver 122, and the revolver drive device 123 of the optical module 120 connected to the Z-plate 130 in the Z-direction. The Z-drive module 140 includes an electric adjustment mechanism 141. By driving the Z-plate 130 in the Z direction by the electric adjustment mechanism 141, the relative distance in the Z direction between the objective lens 121 used for observation and the observation target B is adjusted.

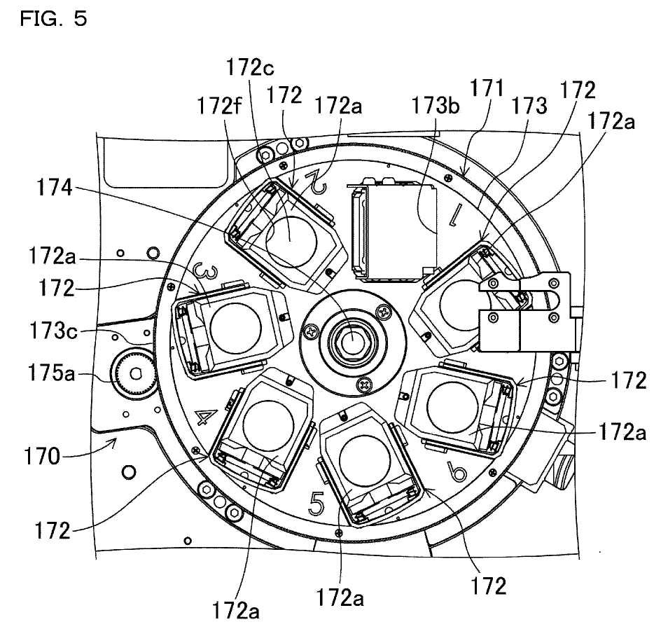

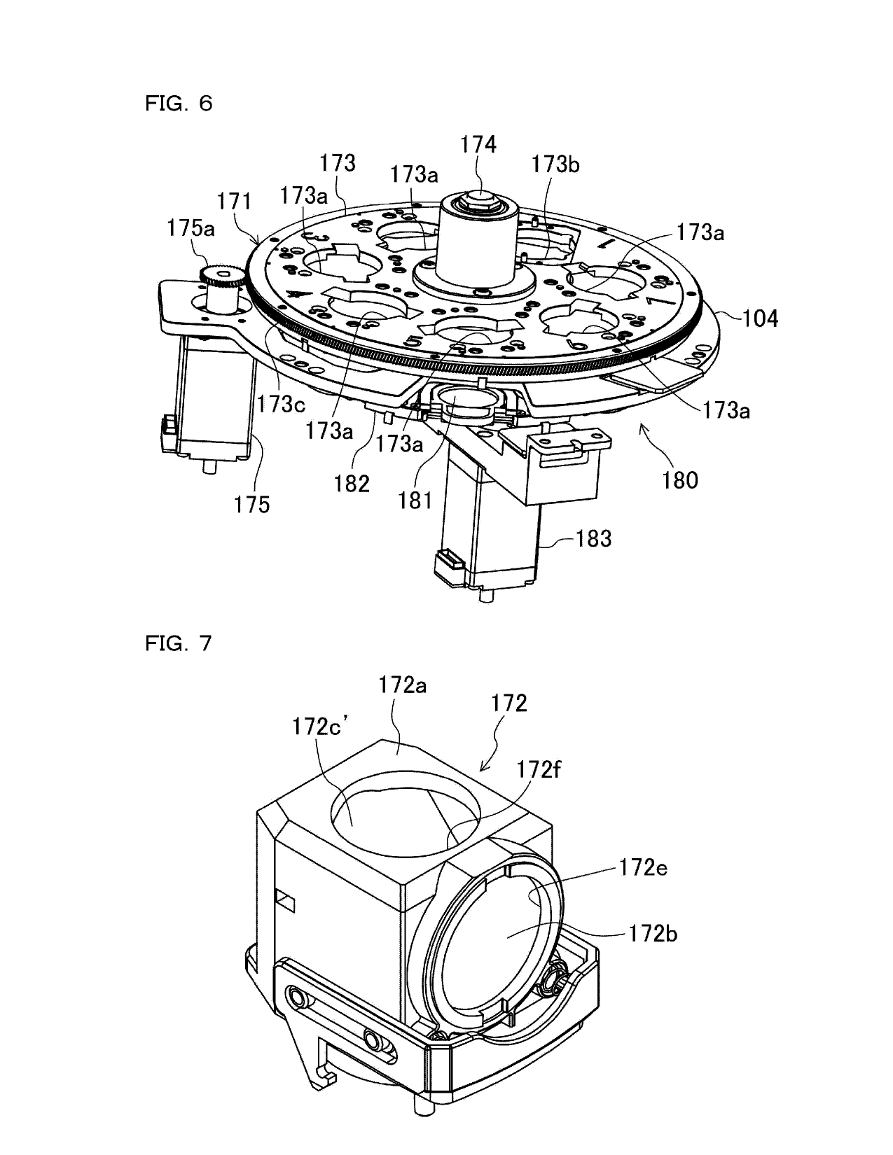

As illustrated in FIGS. 5 and 6, the microscope body 1 includes a filter unit 170 accommodated in the base housing 100. The filter unit 170 is disposed below the revolver 122 and includes a filter switching device 171 and a plurality of filter cubes 172. The filter switching device 171 includes a filter turret 173 to which a plurality of filter cubes 172 is detachably attached, a support shaft 174 that supports the filter turret 173, and a turret drive motor 175.

The support shaft 174 extends in the up and down direction. A portion intermediate in the up and down direction of the support shaft 174 is attached to the lower frame 104. The upper portion of the support shaft 174 protrudes upward from the upper surface of the lower frame 104. A central portion of the filter turret 173 is supported on an upper portion of the support shaft 174 so as to be relatively rotatable.

As illustrated in FIG. 6, the filter turret 173 has a disk shape. In the filter turret 173, a plurality of through holes 173a and 173b penetrating in the up and down direction is formed at intervals in a circumferential direction of the support shaft 174. The intervals between the through holes 173a and 173b in the circumferential direction are equal. In this embodiment, the seven through holes 173a and 173b are formed, and the filter cube 172 can be attached to the six through holes 173a among them, while the filter cube 172 cannot be attached to one through hole 173b.

The through hole 173b formed in the filter turret 173 is a hole for passing light transmitted through the observation target B at the time of transmission observation. At the time of transmission observation, the filter turret 173 is rotated such that the through hole 173b is disposed on the optical path L3 of the light transmitted through the observation target B. In this manner, by rotating the filter turret 173, it is possible to switch between a state (inserted state) in which the filter cube 172 and the absorption filter 172d included in the filter cube 172 are disposed on the observation optical path and a state (removed state) in which the filter cube 172 and the absorption filter 172d included in the filter cube 172 are not disposed. That is, the filter turret 173 is a member that inserts and removes the filter cube 172 and the absorption filter 172d included in the filter cube 172 on the observation optical path.

A large number of driven teeth 173c are provided in the circumferential direction on the outer peripheral portion of the filter turret 173. The turret drive motor 175 is provided with a pinion gear 175a that meshes with the driven teeth 173c. When the turret drive motor 175 is activated to rotate the pinion gear 175a, the filter turret 173 can be rotated about the support shaft 174. The rotation angle of the filter turret 173 can be any rotation angle by controlling the turret drive motor 175.

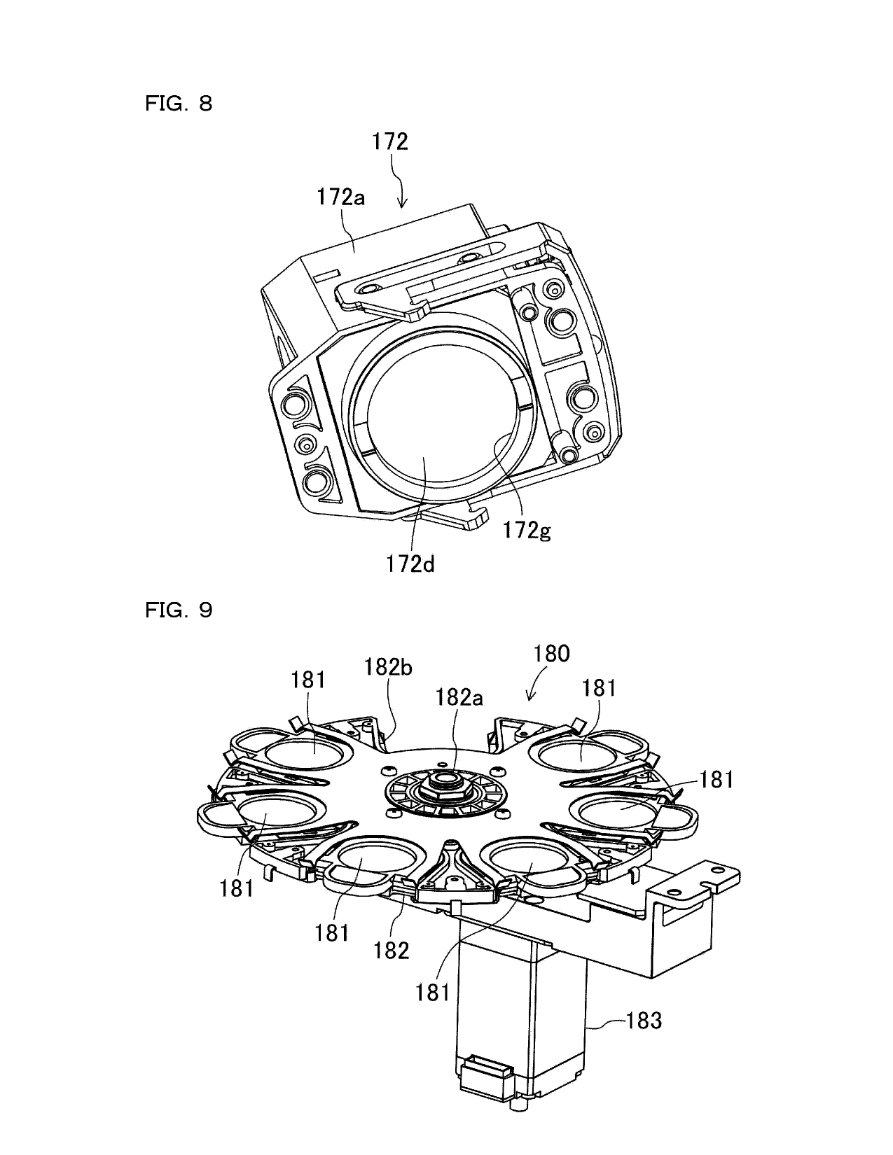

As illustrated in FIGS. 7 and 8, each filter cube 172 includes a frame 172a having an aerial structure, an excitation filter 172b, a dichroic mirror 172c, and an absorption filter 172d. The frame 172a is a cubic member that supports the excitation filter 172b, the dichroic mirror 172c, and the absorption filter 172d. Since each filter cube 172 is disposed below the revolver 122, the excitation filter 172b, the dichroic mirror 172c, and the absorption filter 172d are also disposed below the revolver 122. Since a plurality of the filter cubes 172 is provided, a plurality of excitation filters 172b, a plurality of the dichroic mirrors 172c, and a plurality of the absorption filters 172d are also provided corresponding to the number of filter cubes 172.

The frame 172a includes an entrance window 172e through which the excitation light from the illumination module 110 is incident, an upper emission window 172f through which the excitation light is emitted, and a lower emission window 172g through which the fluorescence generated in the observation target B is emitted. The entrance window 172e is formed on a side surface of the frame 172a, and an excitation filter 172b is provided in the entrance window 172e. The upper emission window 172f is formed on the upper surface of the frame 172a. The lower emission window 172g is formed on the lower surface of the frame 172a, that is, a surface opposed to the surface in the up and down direction on which the upper emission window 172f is formed. The absorption filter 172d is provided in the lower emission window 172g. The absorption filter 172d is an optical member that selectively transmits fluorescence in a predetermined wavelength band among fluorescence collected by the objective lens 121 at the time of fluorescence observation. That is, in the plurality of absorption filters 172d, wavelengths to be transmitted among the fluorescence generated in the observation target B irradiated with the excitation light by the illumination section 31 are different from each other.

A multi-dichroic mirror 172c’ that transmits fluorescence in a plurality of wavelength bands may be provided as the dichroic mirror 172c inside the frame 172a. The dichroic mirror 172c is fixed to the frame 172a in a state of being inclined by a predetermined angle with respect to the Z direction. The excitation light transmitted through the excitation filter 172b provided in the entrance window 172e is reflected upward by the dichroic mirror 172c, passes through the upper emission window 172f, and is emitted upward from the frame 172a. The excitation light having passed through the upper emission window 172f passes through the objective lens 121 and is applied to the observation target B on the stage S.

Since the plurality of filter cubes 172 is attached to the filter turret 173, the plurality of excitation filters 172b, the plurality of dichroic mirrors 172c, and the plurality of absorption filters 172d are disposed in the filter turret 173. By rotating the filter turret 173, the filter cube 172 used at the time of fluorescence observation can be switched to arbitrary one filter cube 172 among the plurality of filter cubes 172. The filter turret 173 is a member in which the plurality of excitation filters 172b, the plurality of dichroic mirrors 172c, and the plurality of absorption filters 172d are rotatably disposed about the support shaft 174 extending in the vertical direction and that switches the excitation filters 172b, the dichroic mirrors 172c, and the absorption filters 172d disposed on the observation optical path.

The microscope body 1 includes a control board 160. The control board 160 is a part that controls each part of the microscope body 1, and includes, for example, a turret control section 160a that controls the filter turret 173. The turret control section 160a is connected to the turret drive motor 175 and controls the turret drive motor 175. By controlling the turret drive motor 175 by the turret control section 160a, the filter turret 173 can be rotated to a desired rotation angle and stopped, whereby one absorption filter 172d disposed on the observation optical path can be sequentially switched. That is, the turret control section 160a is a part that sequentially switches one absorption filter 172d disposed on the observation optical path by the filter turret 173.

One set is formed by the excitation filter 172b, the dichroic mirror 172c, and the absorption filter 172d provided in one filter cube 172. The excitation filter 172b, the dichroic mirror 172c, and the absorption filter 172d provided in each filter cube 172 are different so as to correspond to the fluorescent reagent used at the time of fluorescence observation. In a case where, for example, GFP, TexasRed, DAPI, or the like is used as the fluorescent reagent, the filter cube 172 corresponding to GFP, TexasRed, DAPI, or the like is attached to the filter turret 173.

The excitation filter 172b of the filter cube 172 corresponding to the GFP allows light having a wavelength of around 490 nm to pass therethrough, and the absorption filter 172d allows light having a wavelength of around 510 nm to pass therethrough. The dichroic mirror 172c reflects light having a wavelength of around 490 nm and allows light having a wavelength of around 510 nm to pass therethrough.

Furthermore, the excitation filter 172b of the filter cube 172 corresponding to the TexasRed allows light having a wavelength of around 596 nm to pass therethrough, and the absorption filter 172d allows light having a wavelength of around 620 nm to pass therethrough. The dichroic mirror 172c reflects light having a wavelength of around 596 nm and allows light having a wavelength of around 620 nm to pass therethrough.

Furthermore, the excitation filter 172b of the filter cube 172 corresponding to the DAPI allows light having a wavelength of around 345 nm to pass therethrough, and the absorption filter 172d allows light having a wavelength of around 455 nm to pass therethrough. The dichroic mirror 172c reflects light having a wavelength of around 345 nm and allows light having a wavelength of around 455 nm to pass therethrough.

An emission filter unit 180 as illustrated in FIG. 9 is provided below the filter turret 173, that is, below the dichroic mirror 172c. The emission filter unit 180 includes a plurality of emission filters 181 having mutually different wavelengths to be transmitted among the fluorescence transmitted through the dichroic mirror 172c, a filter wheel 182 to which the plurality of emission filters 181 is detachably attached, and a wheel drive motor 183. Although not illustrated, the wheel drive motor 183 transmits a rotational force to the filter wheel 182 via, for example, a gear.

The plurality of emission filters 181 is disposed at intervals in the circumferential direction of the filter wheel 182. By rotating the filter wheel 182, arbitrary one emission filter 181 of the plurality of emission filters 181 can be disposed on the optical path L2 of fluorescence. The filter wheel 182 is provided with a notch 182b to which the emission filter 181 is not attached. The notch 182b is a part through which the light transmitted through the observation target B passes at the time of transmission observation, and the filter wheel 182 is rotated so that the notch 182b is disposed on the optical path L3 of the light transmitted through the observation target B at the time of transmission observation.

The emission filter 181 is a member for selectively transmitting fluorescence in a specific wavelength band. That is, the plurality of emission filters 181 functions as a multi-filter that transmits fluorescence in a plurality of wavelength bands by sequentially switching the absorption filters disposed on the optical path L2 of fluorescence. For example, the wavelength band of the received fluorescence can be changed by fixing the filter turret 173 in which the multi-band dichroic mirror 172c that transmits fluorescence of a plurality of wavelength bands is disposed and rotating the filter wheel 182 to sequentially switch the emission filter 181.

As illustrated in FIGS. 2 and 3, the microscope body 1 includes a transmitted illumination section 200 that irradiates the observation target B placed on the stage S with observation light. The transmitted illumination section 200 includes a transmitted illumination body 210. The transmitted illumination body 210 includes a transmitted illumination housing 211, and the transmitted illumination housing 211 has a cylindrical shape elongated in the front-rear direction.

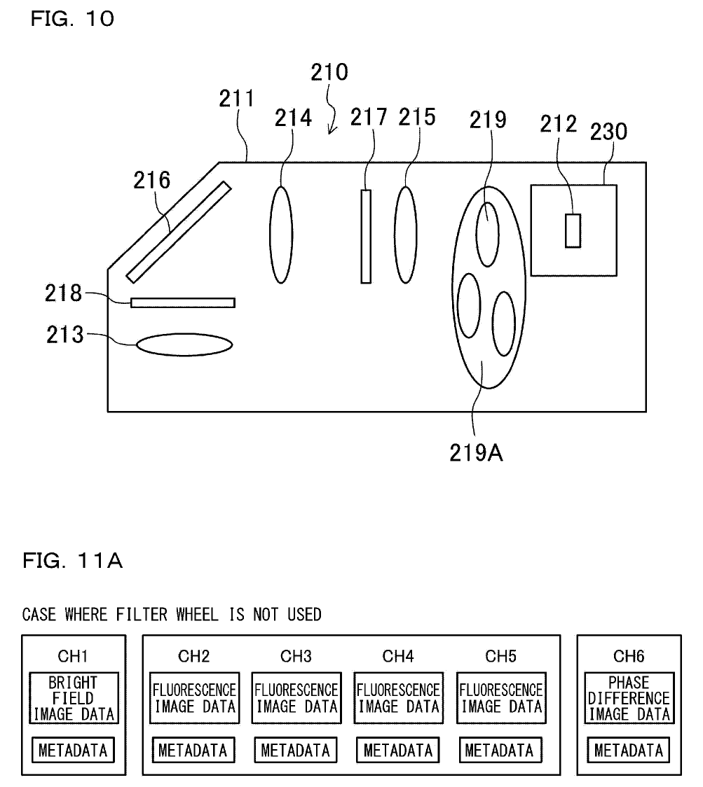

As illustrated in FIG. 10, the transmitted illumination body 210 includes a white light source 212 that emits transmitted illumination light that is illumination light for transmission observation, a filter 219, a condenser lens 213, a relay lens 214, and an illumination lens 215. Here, the filter 219 may be a plurality of filters having transmission bands of a red band, a green band, and a blue band. In this case, each filter is attached to the wheel 219A, and the wavelength with which the observation target B is irradiated can be switched by rotating the wheel 219A. Furthermore, the filter 219 may be an optical element capable of electrically switching the transmission band.

As illustrated in FIG. 10, the illumination lens 215 is disposed in front of a light source accommodation portion 230. Therefore, red light, green light, and blue light sequentially generated by being emitted from the white light source 212 and being transmitted through the filter 219 are incident on the illumination lens 215. The illumination lens 215 is a member for collecting light of different wavelengths sequentially generated by being emitted from the white light source 212 and being transmitted through the filter 219.

The relay lens 214 is a member disposed between the condenser lens 213 and the white light source 212 and having a focal plane at an aperture diaphragm of the condenser lens 213 and a rear focal position of the illumination lens 215. The optical axis of the relay lens 214 and the optical axis of the illumination lens 215 are both oriented in the front-rear direction and coincide with each other.

The transmitted illumination body 210 includes a mirror 216. The mirror 216 is provided in a front portion of the transmitted illumination housing 211. The light emitted forward from the relay lens 214 is incident on the mirror 216 and is reflected downward by the mirror 216.

The condenser lens 213 is a member that is disposed below the mirror 216, collects the light emitted from the white light source 212, and irradiates the observation target B placed on the stage S with transmitted illumination light. The optical axis of the condenser lens 213 is directed in the up and down direction, and the light reflected downward by the mirror 216 is incident on the condenser lens 213 and then exits downward from the condenser lens 213. In such an optical system, the illumination lens 215 is designed to focus the light from the white light source 212 at a position conjugate with the aperture diaphragm position of the relay lens 214.

A first light diffusion plate 217 as a first light homogenizing element is provided at a rear focal position of the illumination lens 215. Moreover, a second light diffusion plate 218 as a second light homogenizing element is provided at the position of the aperture diaphragm of the condenser lens 213. Since the first light diffusion plate 217 and the second light diffusion plate 218 are provided on the optical path of the transmitted illumination light, light beams can be scattered and mixed. Therefore, unevenness of the light emitted from the condenser lens 213 is eliminated, and the light can be brought close to uniform light.

The optical path L3 (illustrated in FIG. 3) of the transmitted light partially overlaps with the optical path L1 of the excitation light. That is, the excitation light is emitted from below to above the stage S. A part of the excitation light transmitted through the observation target B is incident on the condenser lens 213 of the transmitted illumination section 200.

The microscope body 1 includes an imaging module 150. The imaging module 150 is accommodated in the base housing 100 and is provided below the lower frame 104. The imaging module 150 is disposed on the optical path L2 of the fluorescence collected by the optical module 120 and detects the fluorescence collected by the optical module 120, and is disposed on the optical path L3 of the light transmitted through the observation target B and detects the light transmitted through the observation target B. In the present embodiment, the imaging module 150 is provided below the optical module 120.

The imaging module 150 includes a camera 151 and an imaging lens 152. The camera 151 is, for example, a complementary metal oxide semiconductor (CMOS) image sensor including an imaging element. The imaging element is, for example, a monochrome CMOS, and the camera 151 includes a monochrome camera including a monochrome CMOS. The imaging element may be another imaging element such as a charge coupled device (CCD) image sensor.

Fluorescence or transmitted light incident on the imaging module 150 is collected and imaged by the imaging lens 152, and then detected (hereinafter, also referred to as light reception) by the camera 151. Therefore, an image of the observation target B is obtained. An analog electric signal (Hereinafter, referred to as a light reception signal.) corresponding to the amount of received light is output from each pixel of the imaging element of the camera 151 to a control board 160. The camera 151 is an example of a detection section that detects light collected by the objective lens 121 constituting the observation optical system.

Unlike the color CCD, the monochrome CCD constituting the camera 151 of the present embodiment does not need to be provided with a pixel that receives light of a red wavelength, a pixel that receives light of a green wavelength, and a pixel that receives light of a blue wavelength. Therefore, the measurement resolution of the monochrome CCD is higher than the resolution of the color CCD. Furthermore, unlike the color CCD, the monochrome CCD does not need to include a color filter in each pixel. Therefore, the sensitivity of the monochrome CCD is higher than the sensitivity of the color CCD. For these reasons, the camera 151 according to the present embodiment includes a monochrome CCD.

An analog/digital converter (A/D converter), a first in first out (FIFO) memory, and the like (not illustrated) are mounted on the control board 160. The light reception signal output from the camera 151 is sampled at a constant sampling period by the A/D converter and converted into a digital signal on the basis of the control of the electronic computer 2 illustrated in FIG. 1. The digital signals output from the A/D converter are sequentially accumulated in the FIFO memory. The digital signals accumulated in the FIFO memory are sequentially transferred to the electronic computer 2 as pixel data.

As illustrated in FIG. 1, the electronic computer 2 includes, for example, a desktop personal computer or a notebook personal computer, and includes a computer body 20, a display section 21, and an operation section 22. The computer body 20 includes a central processing unit (CPU), a read only memory (ROM), a random access memory (RAM), a storage device, and the like. The ROM stores a system program. The RAM stores various data and functions as a work region of the CPU. The storage device includes a solid state drive, a hard disk drive, or the like. The storage device stores a control program and an image processing program of the fluorescence microscope A. On the basis of the control program and the image processing program, the computer body 20 controls each part of the microscope body 1 and controls the light source unit 3. Furthermore, the storage device is also used to store various data such as image data output from the imaging module 150.

The display section 21 includes, for example, an LCD panel, an organic electroluminescence (EL) panel, or the like. On the display section 21, a user interface screen for performing various settings of the fluorescence microscope A is displayed, and an observation image or the like based on the image data output from the imaging module 150 is displayed.

The operation section 22 includes a member for operating the computer body 20. Examples of the member constituting the operation section 22 include a keyboard and a pointing device. Examples of the pointing device include a mouse and a joystick.

The computer body 20 controls each part of the microscope body 1, so that fluorescence observation using fluorescence can be performed and transmission observation can also be performed. At the time of fluorescence observation, the filter switching device 171 operates and switches to the filter cube 172 corresponding to the fluorescent reagent to be used. Furthermore, the objective lens is switched to a desired objective lens 121 by the revolver drive device 123. Moreover, in a case where the emission filter 181 is used, the emission filter unit 180 operates and is switched to a desired emission filter 181.

The light source unit 3 generates excitation light. The excitation light generated by the light source unit 3 is transmitted to the microscope body 1 via the fiber cable 6, transmitted through the filter cube 172 and the objective lens 121, and then applied to the observation target B. At the time of observation, the Z-drive module 140 operates, and focus adjustment is automatically executed.

The fluorescence generated in the observation target B is incident on the objective lens 121, then is transmitted through the filter cube 172 and the emission filter 181, and is incident on the imaging module 150. When the filter turret 173 is controlled by the turret control section 160a, the filter turret 173 switches the filter cube 172 disposed on the observation optical path. Since the filter cube 172 is sequentially switched by this switching operation, the fluorescence transmitted through one absorption filter 172d disposed on the observation optical path can be sequentially detected by the camera 151.

Furthermore, it is also possible to sequentially switch the emission filter 181 in a state where arbitrary one dichroic mirror 172c is disposed on the observation optical path by the filter turret 173 controlled by the turret control section 160a. The wavelength band of the fluorescence detected by the camera 151 can also be sequentially switched by sequentially switching the emission filter 181.

The fluorescence incident on the imaging module 150 is received by the camera 151. The analog electric signal corresponding to the amount of received light is output from the control board 160 to the computer body 20 to generate image data, and a fluorescence image is displayed on the display section 21.

At the time of transmission observation, the observation target B is irradiated with the transmitted light emitted from the transmitted illumination section 200. In the transmission observation, the filter switching device 171 operates, and the filter cube 172 is not disposed on the optical path L3 of the transmitted light. Furthermore, the objective lens is switched to a desired objective lens 121 by the revolver drive device 123. Moreover, the emission filter unit 180 operates, and the emission filter 181 is not disposed on the optical path L3 of the transmitted light. Also at the time of transmission observation, the Z-drive module 140 operates, and focus adjustment is automatically executed. At the time of transmission observation, the camera 151 can receive the transmitted light transmitted through the observation target B in a state where the absorption filter 172d is disposed outside the observation optical path by the filter turret 173.

Specifically, the transmitted light transmitted through the observation target B is incident on the objective lens 121, and then is incident on the imaging module 150 without being transmitted through the filter cube 172 and the emission filter 181. The transmitted light incident on the imaging module 150 is received by the camera 151. An analog electric signal corresponding to the amount of received light is output from the control board 160 to the computer body 20. The computer body 20 is provided with an image processing section 24. The image processing section 24 generates a non-fluorescence image including, for example, a phase difference image, a bright field image, and the like on the basis of the transmitted light detected by the camera 151. In this manner, the image processing section 24 generates both the phase difference image and the bright field image as the non-fluorescence image.

The non-fluorescence image generated by the image processing section 24 is displayed on the display section 21. Note that the phase difference image is an image that can visualize the transparent structure of the unstained observation target B by utilizing a difference in refractive index of the observation target B. Furthermore, the bright field image is an image in which the structure can be viewed with the color or shade of the observation target B itself by directly observing the transmitted light passing through the objective lens 121.

In the present embodiment, both the fluorescence and the transmitted light are detected by the common camera 151, but the present invention is not limited thereto, and a first detection section that sequentially detects fluorescence transmitted through one absorption filter 172d disposed on the observation optical path by the turret control section 160a and a second detection section that detects transmitted light of the observation target B irradiated with the illumination light may be included as the detection section of light.

The fluorescence microscope A of the present embodiment has a color observation function of generating a color image of the observation target B without using a color image generation filter applied at the time of conventional color image generation. The color observation function of the fluorescence microscope A can be realized by the white light source 212, the filter 219, and the transmitted illumination control section 23 and the image processing section 24 illustrated in FIG. 2.

The transmitted illumination control section 23 controls the white light source 212 of the transmitted illumination section 200 to emit light. Furthermore, the transmitted illumination control section 23 sequentially switches, in a time division manner, the wavelength of the light with which the observation target B is irradiated by driving the wheel 219A holding the filter 219. Specifically, the transmitted illumination control section 23 drives the wheel 219A holding the filter 219 so as to transmit only the light of the first wavelength, thereby irradiating the observation target B with the red light. Furthermore, the transmitted illumination control section 23 drives the wheel 219A holding the filter 219 so as to transmit only the light of the second wavelength, thereby irradiating the observation target B with the green light. Moreover, the transmitted illumination control section 23 drives the wheel 219A holding the filter 219 so as to transmit only the light of the third wavelength, thereby irradiating the observation target B with blue light. As described above, the transmitted illumination control section 23 drives the wheel 219A holding the filter 219 to sequentially switch, in a time division manner, the wavelength of the light with which the observation target B is irradiated, and controls the transmitted illumination section 200 so as to emit light having wavelengths different from each other. Here, although not illustrated, in a case where an optical element capable of electrically switching the transmission band is used as the filter, the transmitted illumination control section 23 irradiates the observation target B with red light by driving the filter to transmit only light of the first wavelength. Furthermore, the transmitted illumination control section 23 drives the filter so as to transmit only the light of the second wavelength, thereby irradiating the observation target B with the green light. Moreover, the transmitted illumination control section 23 drives the filter so as to transmit only the light of the third wavelength, thereby irradiating the observation target B with blue light. As described above, the transmitted illumination control section 23 drives the wheel 219A on which the filter 219 is held or the filter using the optical element capable of electrically switching the transmission band, thereby sequentially switching, in a time division manner, the wavelength of the light with which the observation target B is irradiated, and controlling the transmitted illumination section 200 so as to emit light having wavelengths different from each other. Note that the order of red light irradiation, blue light irradiation, and green light irradiation is not particularly limited.

In the case of red light irradiation, the red light transmitted through the observation target B is received by the camera 151. Thereafter, when blue light irradiation is performed, the blue light transmitted through the observation target B is received by the camera 151. Thereafter, when green light irradiation is performed, the green light transmitted through the observation target B is received by the camera 151. In this manner, the camera 151 sequentially receives transmitted light of different wavelengths transmitted through the observation target B.

The image processing section 24 is a part that generates a color image that is an observation image on the basis of transmitted light of different wavelengths sequentially received by the camera 151. That is, an analog electrical signal corresponding to the amount of received red light when the red light transmitted through the observation target B is received by the camera 151, an analog electrical signal corresponding to the amount of received blue light when the blue light transmitted through the observation target B is received by the camera 151, and an analog electrical signal corresponding to the amount of received green light when the green light transmitted through the observation target B is received by the camera 151 are transmitted to the image processing section 24. The image processing section 24 synthesizes three monochrome images generated by the received three analog electrical signals to generate a color image.

Next, a case of generating a monochrome image will be described. In a case of generating a monochrome image, the transmitted illumination control section 23 turns on the white light source 212 and irradiates the observation target B with white light. Furthermore, the transmitted illumination control section 23 transmits the white light emitted from the white light source 212 by rotating the wheel 219A having an empty hole in which the filter 219 is not disposed and driving the wheel 219A such that the empty hole is disposed on the optical path. Furthermore, in the case of a filter that electrically switches the transmission band, a mechanism that inserts and removes the filter onto and from the optical path may be further provided, and the observation target B may be irradiated with white light emitted from the white light source 212 by driving the filter to be removed from the optical path. The image processing section 24 generates a monochrome image on the basis of transmitted light of white light received by the camera 151.

The image processing section 24 can also generate a pseudo color image. In a case where the image processing section 24 generates the pseudo color image, the fluorescence sequentially detected by the camera 151 and the wavelength band of the absorption filter 172d disposed on the observation optical path are acquired. The image processing section 24 generates a plurality of pseudo color images on the basis of the fluorescence sequentially detected by the camera 151 and the wavelength band of the absorption filter 172d disposed on the observation optical path.

The plurality of pseudo color images generated on the basis of the fluorescence transmitted through the absorption filter 172d of the filter cube 172 is high brightness fluorescence images. On the other hand, since the dichroic mirror 172c is a mirror corresponding to a plurality of wavelengths, the pseudo color image generated on the basis of the fluorescence transmitted through the dichroic mirror 172c and the emission filter 181 becomes a low brightness fluorescence image having lower brightness than the image generated on the basis of the fluorescence transmitted through the absorption filter 172d of the filter cube 172.

Furthermore, since it is difficult to rotate a plurality of the filter cubes 172 provided in the filter turret 173 at a high speed, the plurality of pseudo color images generated on the basis of the fluorescence transmitted through the absorption filter 172d of the filter cube 172 is low-speed captured fluorescence images. On the other hand, since the plurality of emission filters 181 provided in the filter wheel 182 can be rotated at a higher speed than the filter cube 172, the pseudo color image generated on the basis of the fluorescence transmitted through the dichroic mirror 172c and the emission filter 181 is a high-speed captured fluorescence image.

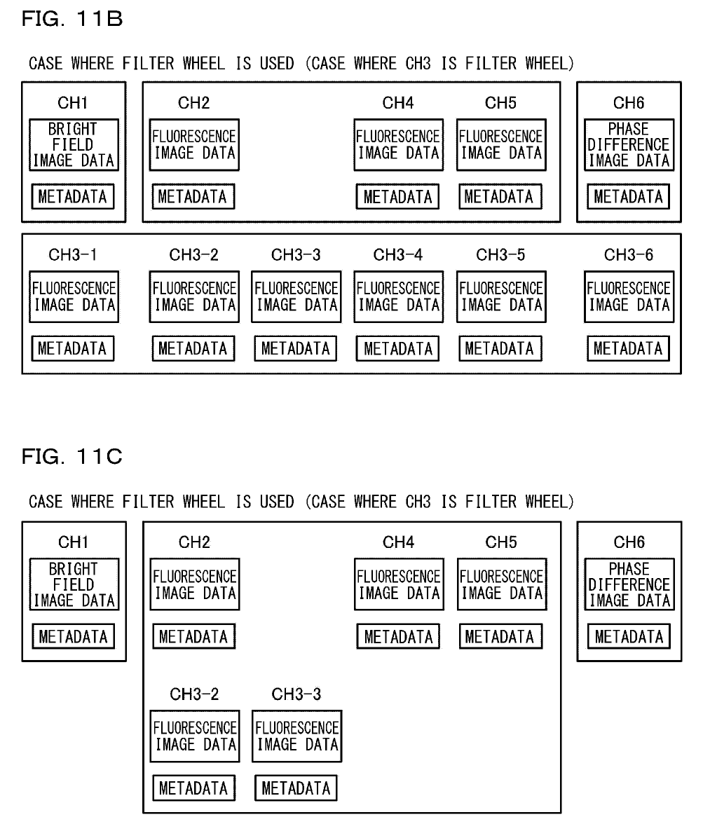

FIG. 11A is a diagram illustrating an example of an image that can be acquired by the fluorescence microscope A in a case where the filter wheel 182 is not used. Furthermore, FIG. 11B is a diagram illustrating an example of an image that can be acquired by the fluorescence microscope A in a case where the filter wheel 182 is used. Moreover, FIG. 11C is a diagram according to another example in a case where the filter wheel 182 is used.

As illustrated in these drawings, in the fluorescence microscope A, a plurality of observation channels can be set. In this example, the observation channel includes a first channel (CH1) for acquiring bright field image data, second to fifth channels (CH2 to CH5) for acquiring fluorescence image data, and a sixth channel (CH6) for acquiring phase difference image data. Metadata is associated with each piece of image data. The metadata includes, for example, a focus value, imaging time, and the like. Note that the first channel may be a channel for acquiring a pseudo color image or a transmission observation image.

In a case where the filter wheel 182 is not used, a plurality of pieces of fluorescence image data can be acquired by switching the plurality of filter cubes 172. On the other hand, for example, in a case where the filter wheel 182 is used in the third channel, a plurality of pieces of fluorescence image data of CH3-1 to CH3-6 can be acquired by rotating the filter wheel 182 to switch the emission filter 181.

Note that FIGS. 11A to 11C are examples of image acquisition, and any two pieces of image data among the bright field image data, the phase difference image data, and the fluorescence image data may not be included. Furthermore, there may be a case where the number of observation channels is one. For example, only bright field image data, or only phase difference image data, or only fluorescence image data may be acquired.

In a case where the image processing section 24 generates both the pseudo color image and the non-fluorescence image (bright field image, phase difference image), the observation channel is associated with each of the pseudo color image and the non-fluorescence image. That is, the observation channel of the pseudo color image is associated with the pseudo color image, and the observation channel of the non-fluorescence image is associated with the non-fluorescence image.

As illustrated in FIG. 2, the fluorescence microscope A includes a display control section 60, a group image generation section 61, a specification section 62, a number-of-groups determination section 63, a stitching section 64, and a determination section 65 as parts that execute generation of various user interface screens, display control of the various user interface screens, control of each section, and various processes. The display control section 60, the group image generation section 61, the specification section 62, the number-of-groups determination section 63, the stitching section 64, and the determination section 65 can be configured by a computer body 20 of the electronic computer 2. For example, the display control section 60, the group image generation section 61, the specification section 62, the number-of-groups determination section 63, the stitching section 64, and the determination section 65 can be configured by a combination of hardware of the computer body 20 and a program executed by the computer body 20.

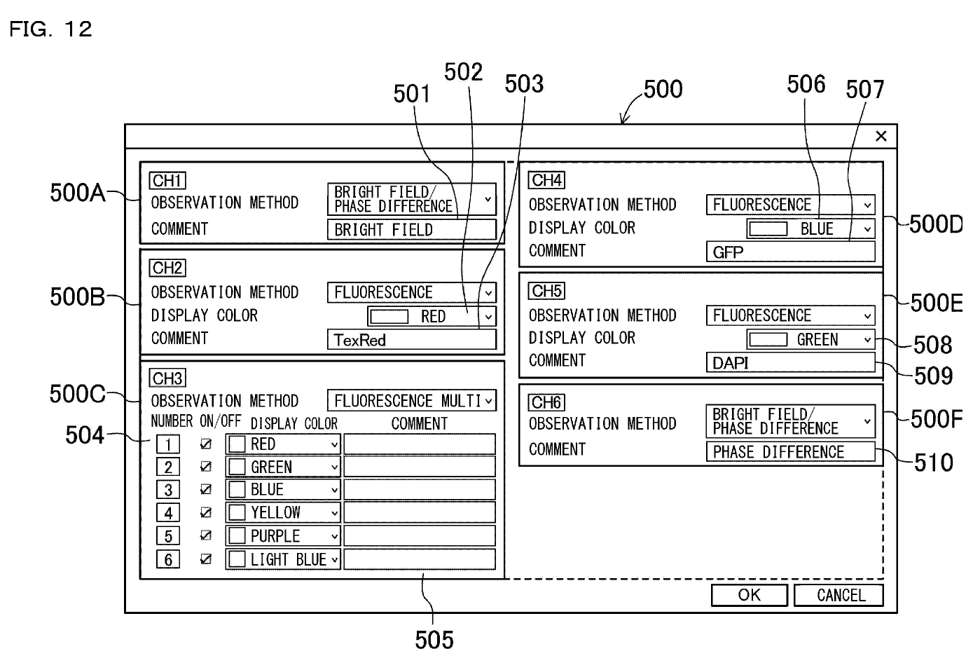

The display control section 60 is a part that generates various user interface screens and displays the screens on the display section 21. FIG. 12 is a diagram illustrating an example of a setting user interface screen 500 generated by the display control section 60 and displayed on the display section 21. The setting user interface screen 500 is a screen that receives a setting of fluorescence observation as an observation method and a setting of a display color for each observation channel corresponding to the absorption filter 172d disposed on the observation optical path. Specifically, the setting user interface screen 500 is provided with channel setting regions 500A to 500F in which observation channels can be set. In this embodiment, since six channels (CH1 to CH6) are set as observation channels, six channel setting regions 500A to 500F are displayed. However, the number of channel setting regions is not limited to six, and may be one or plural. “CH1”, “CH2”, ... are channel numbers.

In each of the channel setting regions 500A to 500F, settings of fluorescence observation, fluorescence multi-observation, bright field observation, and phase difference observation can be received as observation channels. Since the bright field observation and the phase difference observation are the non-fluorescence observation, the setting user interface screen 500 can also receive the setting of the non-fluorescence observation as the observation method.

The channel setting region 500A of “CH1” indicates a case where the setting of the bright field observation is received as the observation channel. The display control section 60 receives an input of a comment “bright field” in a comment display region 501 of the channel setting region 500A.

The channel setting region 500B of “CH2” indicates a case where the setting of the fluorescence observation is received as the observation channel. When receiving the setting of the fluorescence observation, the display control section 60 displays a display color setting region 502 in the channel setting region 500B. In the display color setting region 502, a color corresponding to the fluorescent reagent can be set, and for example, red, blue, green, and the like can be set. In this example, red is selected. The display control section 60 receives an input of a comment “TexasRed” in a comment display region 503 of the channel setting region 500B.

The channel setting region 500C of “CH3” indicates a case where the setting of the fluorescence multi-observation is received as the observation channel. When the setting of the fluorescence multi-observation is received, the display control section 60 displays a plurality of subchannels corresponding to the observation channel of the fluorescence multi-observation in a subchannel display region 504 of the channel setting region 500C. A display color can be set for each subchannel. The display control section 60 receives an input of a comment corresponding to each display color in a comment display region 505 of the channel setting region 500C.

The channel setting region 500D of “CH4” indicates a case where the setting of the fluorescence observation is received as the observation channel. When receiving the setting of the fluorescence observation, the display control section 60 displays a display color setting region 506 in the channel setting region 500D. In the display color setting region 506, blue is set. The display control section 60 receives an input of a comment “GFP” in a comment display region 507 of the channel setting region 500D.

The channel setting region 500E of “CH5” also indicates a case where the setting of the fluorescence observation is received as the observation channel. When receiving the setting of the fluorescence observation, the display control section 60 displays a display color setting region 508 in the channel setting region 500E. In the display color setting region 508, green is set. The display control section 60 receives an input of a comment “DAPI” in a comment display region 509 of the channel setting region 500E.

The channel setting region 500F of “CH6” indicates a case where the setting of the phase difference observation is received as the observation channel. The display control section 60 receives an input of a comment “phase difference” in a comment display region 510 of the channel setting region 500F.

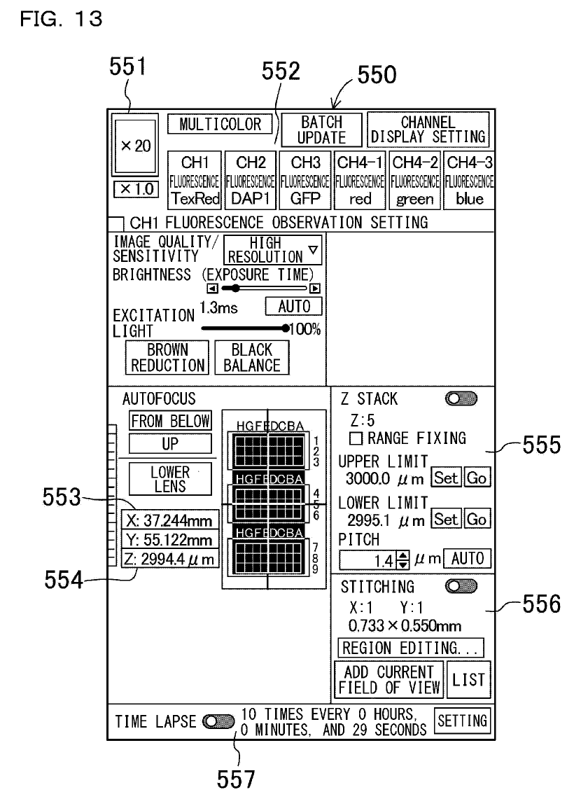

FIG. 13 illustrates a setting screen 550 for multidimensional imaging. On the multidimensional imaging setting screen 550, multidimensional imaging information can be set. The multidimensional imaging means imaging with different channels, imaging with different XY positions, imaging with different Z positions (also referred to as Z heights), and imaging with different times.

The setting screen 550 for the multidimensional imaging is provided with a lens selection region 551, a channel selection region 552, an XY position setting region 553, a Z position setting region 554, a Z stack setting region 555, a stitching setting region 556, and a time lapse setting region 557.

In the lens selection region 551, the objective lens 121 can be selected. Specifically, in a case where the objective lenses 121 having a plurality of different magnifications are attached to the revolver 122, information regarding the objective lenses 121 having the plurality of different magnifications is displayed in the lens selection region 551, and the user operates the lens selection region 551, so that the objective lens 121 having a magnification to be used for observation can be selected from the plurality of objective lenses 121. The information regarding the objective lens 121 is, for example, a magnification, an observation type (bright field observation, dark field observation, phase difference observation, differential interference observation, fluorescence observation), and the like.

In the channel selection region 552, dark field observation and phase difference observation can be selected, and a color channel at the time of fluorescence observation can be selected.

In the XY position setting region 553, it is possible to receive setting of an XY position for acquiring an image. In the Z position setting region 554, setting of a Z position (Z height) for acquiring an image can be received.

In the Z stack setting region 555, it is possible to set a Z stack for acquiring a plurality of images with different imaging heights. For example, settings of the number of images to be acquired, the upper limit of the imaging height, the lower limit of the imaging height, the imaging pitch, and the like can be received in the Z stack setting region 555.

In the stitching setting region 556, it is possible to set image stitching in which the observation target B is moved in the XY direction to acquire and stitch a plurality of images. For example, settings of the number of images to be stitched, a region to be imaged, and the like can be received in the stitching setting region 556. The processing of stitching the plurality of images is executed by the stitching section 64.

In the time lapse setting region 557, it is possible to set time lapse for acquiring a plurality of images at time intervals. For example, setting of a time interval of imaging, setting of the number of images to be acquired, and the like can be received in the time lapse setting region 557.

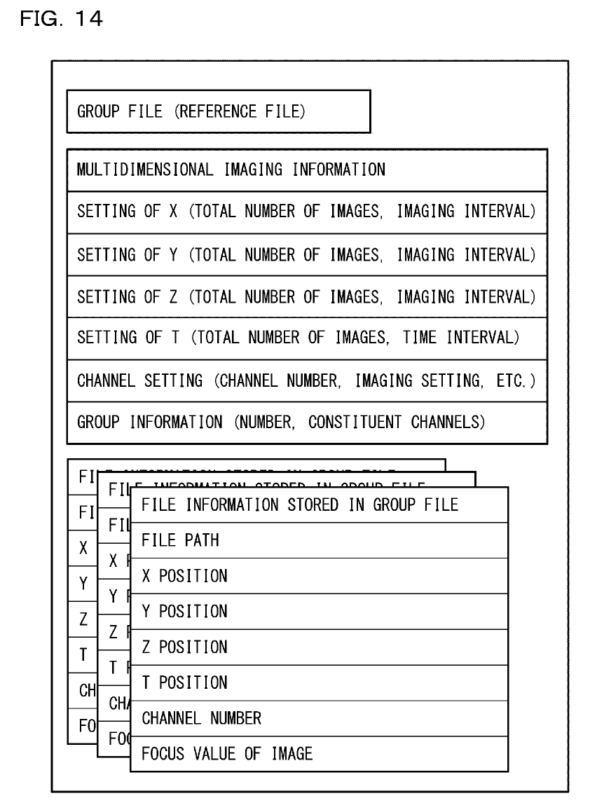

The captured image can be stored in the storage section 70 (illustrated in FIG. 1) of the electronic computer 2 as a group file as illustrated in FIG. 14. The storage section 70 includes, for example, a solid state drive, a hard disk drive, or the like. The storage section 70 may be installed in a place different from the place where the microscope body 1 is installed.

The group file can also be referred to as a reference file. The group file includes, as the multidimensional imaging information, a setting of X (total number of images, imaging interval), a setting of Y (total number of images, imaging interval), a setting of Z (total number of images, imaging interval), a setting of T (time) (total number of images, imaging interval), a setting of a channel (channel number, imaging setting), group information (number, constituent channels), and the like. Furthermore, the group file includes a file path, an X position, a Y position, a Z position, a T position, a channel number, a focus value of an image, and the like as information stored in the group file. The multidimensional imaging information and the file information are information included in the metadata.

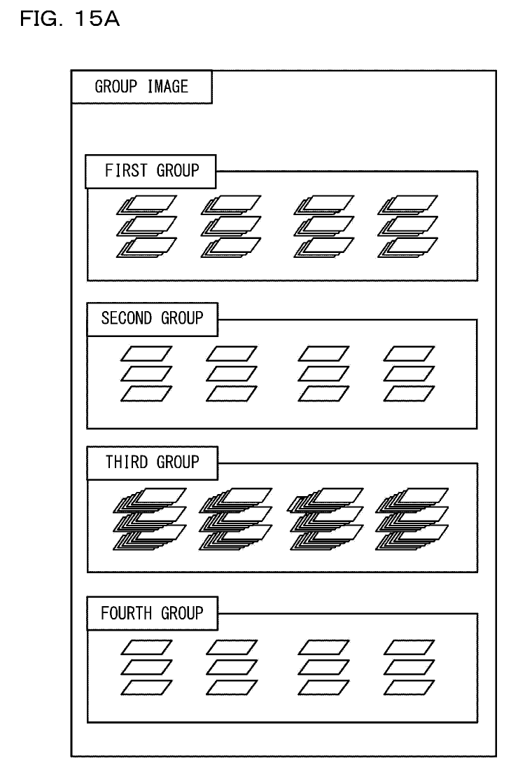

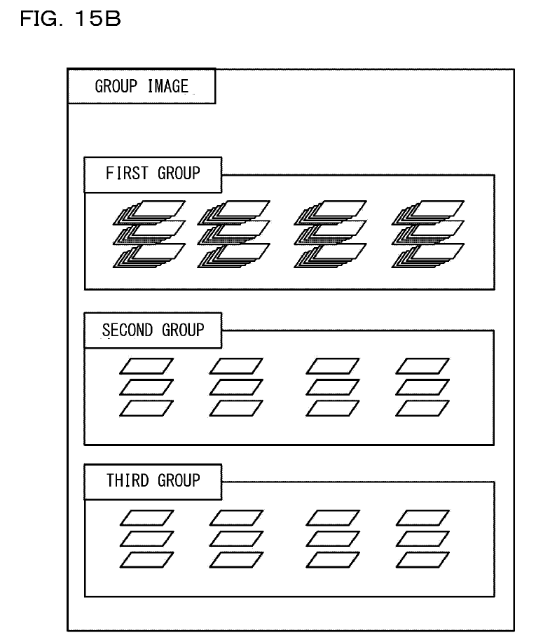

When the group file is generated, the group image generation section 61 divides the acquired plurality of images into first to fourth groups as illustrated in FIG. 15A as an example. Specifically, the group image generation section 61 sets the plurality of pseudo color images generated by the image processing section 24 as images belonging to the first group, and sets the non-fluorescence images generated by the image processing section 24 as images belonging to the second group. At this time, the group image generation section 61 sets a plurality of pseudo color images generated on the basis of the fluorescence transmitted through the absorption filter 172d of the filter cube 172 among the plurality of pseudo color images generated by the image processing section 24 as images belonging to the first group, and sets a plurality of pseudo color images generated on the basis of the fluorescence transmitted through the dichroic mirror 172c and the emission filter 181 as images belonging to the third group. Moreover, the group image generation section 61 sets phase difference images generated by the image processing section 24 as images belonging to the second group, and sets bright field images generated by the image processing section 24 as images belonging to the fourth group.

Furthermore, when the group file is generated, the group image generation section 61 may divide the acquired plurality of images into the first to third groups as illustrated in FIG. 15B as an example. Specifically, the group image generation section 61 sets the plurality of pseudo color images generated by the image processing section 24 as images belonging to the first group, and sets the non-fluorescence images generated by the image processing section 24 as images belonging to the second group. At this time, the group image generation section 61 sets, among the plurality of pseudo color images generated by the image processing section 24, a plurality of pseudo color images generated on the basis of the fluorescence transmitted through the absorption filter 172d of the filter cube 172 and a plurality of pseudo color images generated on the basis of the fluorescence transmitted through the dichroic mirror 172c and the emission filter 181 as images belonging to the first group. Moreover, the group image generation section 61 sets phase difference images generated by the image processing section 24 as images belonging to the second group, and sets bright field images generated by the image processing section 24 as images belonging to the third group.

In this manner, the group image generation section 61 groups the pseudo color images and groups the non-fluorescence images for each observation method of which setting is received on the setting user interface screen 500.

When the pseudo color image is acquired, in a case where the Z stack and the image stitching are set in FIG. 13, a plurality of images acquired at positions having different Z heights and a plurality of images acquired at different XY positions are acquired as the pseudo color images. In this case, the plurality of pseudo color images belonging to the first group includes a plurality of images acquired at positions having different Z heights and a plurality of images acquired at different XY positions.

Furthermore, when the non-fluorescence image is acquired, in a case where the Z stack and the image stitching are set in FIG. 13, a plurality of images acquired at positions having different Z heights and a plurality of images acquired at different XY positions are acquired as the non-fluorescence images. In this case, the non-fluorescence images belonging to the second group include a plurality of images acquired at positions having different Z heights and a plurality of images acquired at different XY positions.

Furthermore, when the pseudo color image is acquired, in a case where the time lapse imaging is set in FIG. 13, a plurality of images acquired at different times is acquired as the pseudo color images. In this case, the plurality of pseudo color images belonging to the first group includes a plurality of images acquired at different times.

Furthermore, when the non-fluorescence image is acquired, in a case where the time lapse imaging is set in FIG. 13, a plurality of images acquired at different times is acquired as the non-fluorescence images. In this case, the non-fluorescence images belonging to the second group include a plurality of images acquired at different times.

The storage section 70 stores images belonging to the first group, images belonging to the second group, images belonging to the third group, and images belonging to the fourth group. At this time, each image is associated with metadata, and the image and the metadata are stored in the storage section 70.

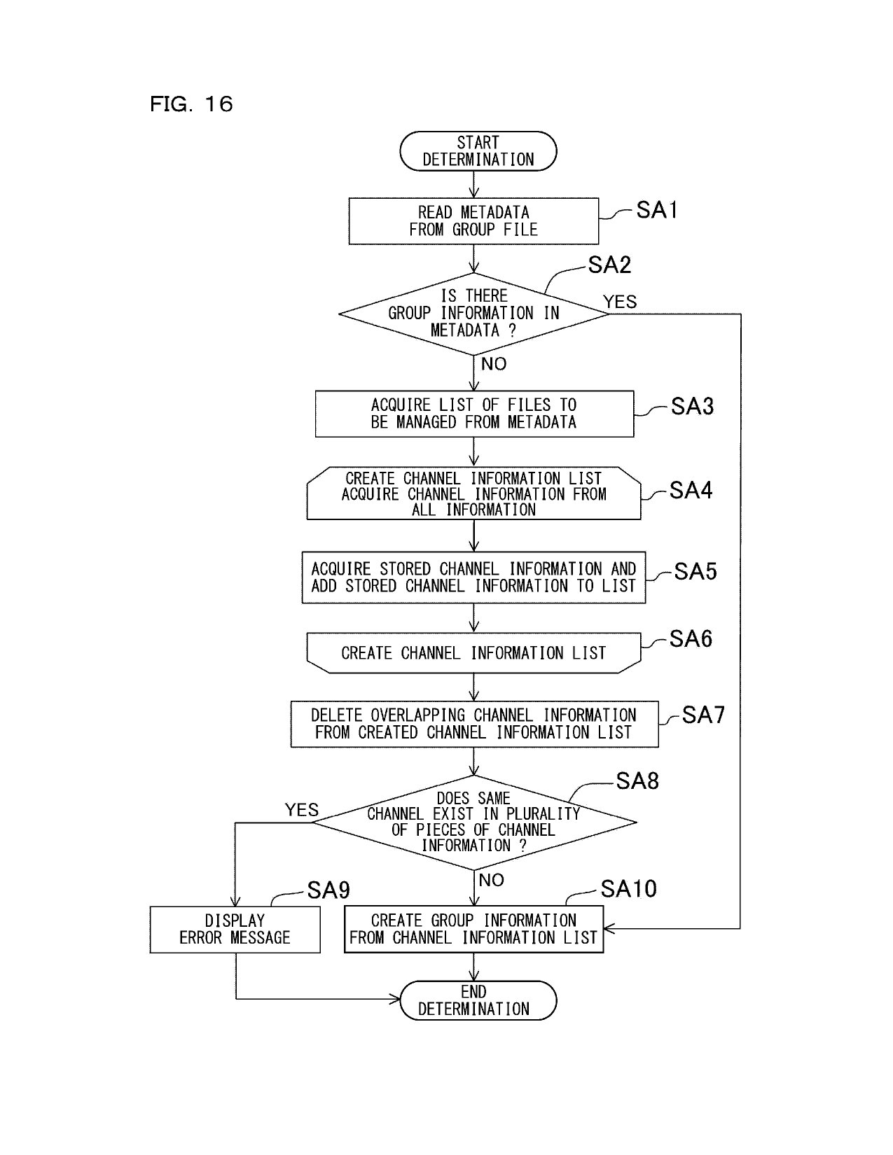

The number-of-groups determination section 63 determines the number-of-groups of groups stored in the storage section 70. FIG. 16 is a flowchart illustrating determination processing of the number-of-groups by the number-of-groups determination section 63. This flowchart may be started on the basis of an instruction from the user, or may be automatically started when a predetermined number or more of images are accumulated.

After starting the determination, in step SA1, the number-of-groups determination section 63 reads the metadata from the group file stored in the storage section 70. In step SA2, the number-of-groups determination section 63 determines whether or not there is group information in the metadata read in step SA1. In a case where there is group information, the process proceeds to step SA10, whereas in a case where there is no group information, the process proceeds to step SA3.

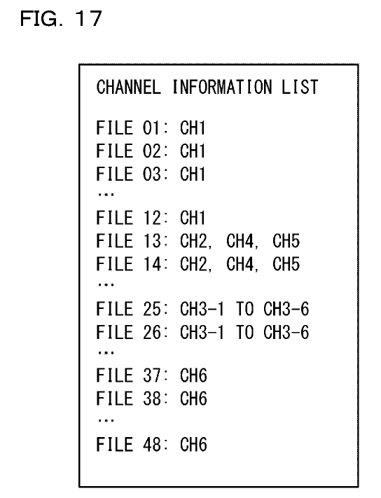

In step SA3, the number-of-groups determination section 63 acquires a list of files to be managed from the metadata. In step SA4, the number-of-groups determination section 63 starts the channel information list creation processing, and first, acquires channel information (observation channels) from all the information. Thereafter, the process proceeds to step SA5, where the stored channel information is acquired and added to the list. In step SA6, a channel information list is created. FIG. 17 illustrates an example of the channel information list. As illustrated in this drawing, the channel information list may include overlapping channel information (channel numbers).

In step SA7, the number-of-groups determination section 63 deletes overlapping channel information from the created channel information list. In step SA8, the number-of-groups determination section 63 determines whether or not the same channel exists in a plurality of pieces of the channel information. In a case where the same channel exists in the plurality of pieces of channel information, the process proceeds to step SA9, and the display control section 60 causes the display section 21 to display an error message. In this manner, the number-of-groups determination section 63 determines the number-of-groups on the basis of the unique number of observation channels associated with the pseudo color image or the non-fluorescence image generated by the image processing section 24. Since the number of unique values after the overlap has been deleted is the unique number, the number-of-groups without the overlap can be obtained by determining the number-of-groups on the basis of the unique number.

In a case where the same channel does not exist in the plurality of pieces of channel information, the process proceeds to step SA10. In step SA10, the number-of-groups determination section 63 creates group information from the channel information list.

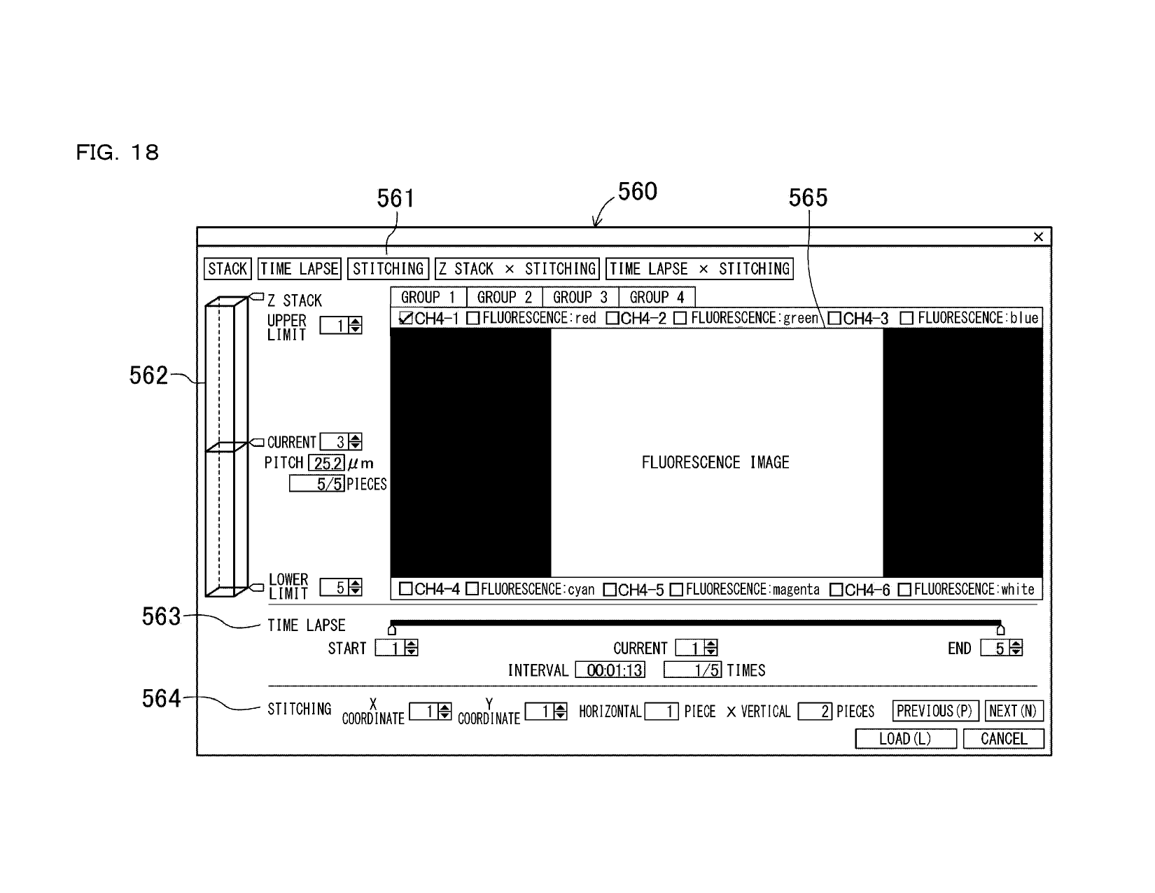

The specification section 62 is a part that specifies a predetermined group such as a group that the user wants to observe among the plurality of groups stored in the storage section 70. The display control section 60 causes the display section 21 to display the images belonging to the predetermined group specified by the specification section 62. When the images belonging to the predetermined group are displayed, for example, the display control section 60 generates a group display screen 560 as illustrated in FIG. 18 and causes the display section 21 to display the screen.

The group display screen 560 is provided with a selection region 561 for multidimensional imaging. In the selection region 561 for the multidimensional imaging, selection of a Z stack, selection of time lapse, selection of image stitching, selection of Z stack × image stitching, selection of time lapse × image stitching, and the like are possible. FIG. 18 illustrates an example in which the Z stack is selected.

The group display screen 560 is provided with a Z position designation region 562 for designating a Z position, a T position designation region 563 for designating a position (T position) in the time axis direction, and an XY position designation region 564 for designating an XY position at the time of image stitching. Moreover, the group display screen 560 is provided with a group image display region 565 in which images belonging to a predetermined group are displayed. The images displayed in the group image display region 565 can be switched by changing the multidimensional imaging information in the selection region 561 for the multidimensional imaging.

When the user designates the Z position in the Z position designation region 562, an image of the designated Z position is specified, and the specified image is displayed in the group image display region 565. Furthermore, when the user designates the T position in the T position designation region 563, the image of the designated T position is specified, and the specified image is displayed in the group image display region 565. Furthermore, when the user designates an XY position in the XY position designation region 564, an image of the designated XY position is specified, and the specified image is displayed in the group image display region 565.

The T position designation region 563 may not be always displayed, and may be displayed only in a predetermined case. That is, the determination section 65 illustrated in FIG. 2 is, for example, a part that determines whether or not a plurality of pseudo color images included in the first group has been acquired chronologically at different times. The determination section 65 acquires metadata associated with each piece of image data, and this determination can be made on the basis of the acquired metadata. In a case where the determination section 65 determines that the plurality of pseudo color images included in the first group image has been acquired chronologically at different times, the display control section 60 causes the display section 21 to display the T position designation region 563 including a time change icon.

Furthermore, the Z position designation region 562 may not be always displayed, and may be displayed only in a predetermined case. That is, the determination section 65 can also determine, for example, whether or not a plurality of pseudo color images included in the first group image has been acquired at different Z heights. The determination section 65 acquires metadata associated with each piece of image data, and this determination can be made on the basis of the acquired metadata. In a case where the determination section 65 determines that the plurality of pseudo color images included in the first group image has been acquired at different Z heights, the display control section 60 causes the display section 21 to display the Z position designation region 562 including a height change icon.

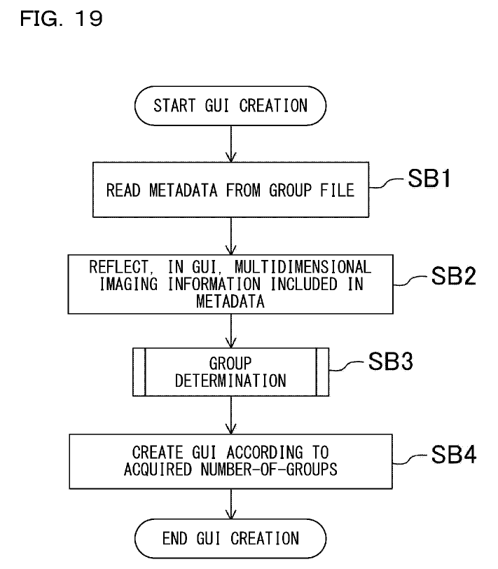

Hereinafter, a specific example of a process of displaying the images belonging to the predetermined group on the display section 21 will be described on the basis of the flowchart illustrated in FIG. 19. FIG. 19 is a flowchart illustrating generation processing of the group display screen 560. In the flowchart of FIG. 19, the group display screen 560 is referred to as “GUI”. This flowchart can be started on the basis of an instruction from the user, and the display control section 60, the group image generation section 61, the specification section 62, the number-of-groups determination section 63, and the like execute each step.

In step SB1, metadata is read from the group file stored in the storage section 70. In step SB2, processing of reflecting, on the group display screen 560, the multidimensional imaging information included in the metadata read in step SB1 is executed. In step SB3, the process of the flowchart illustrated in FIG. 16 is executed. In step SB4, the group display screen 560 is created according to the number-of-groups acquired in the processing of step SB3.

FIG. 18 illustrates a mode in which only an image (for example, a fluorescence image) of one channel is displayed in the group image display region 565. In this display mode, since the image displayed in the group image display region 565 can be enlarged, details can be easily confirmed.

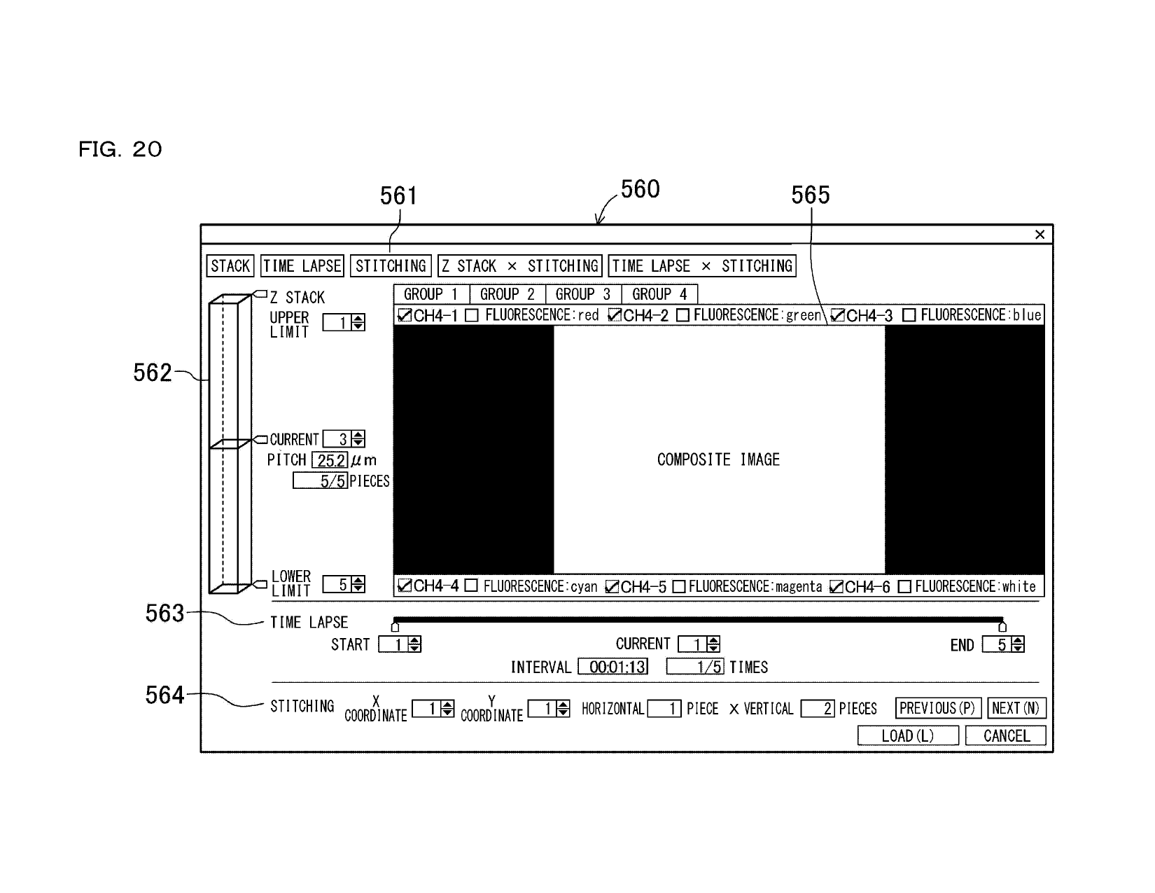

FIG. 20 illustrates a mode in which a plurality of images stored in the same file, such as composite images, is superimposed and displayed in the group image display region 565. In this display mode, since the image in which the structure of the observation target B is visualized can be displayed in the group image display region 565, it is easy to confirm the structure of the observation target B.

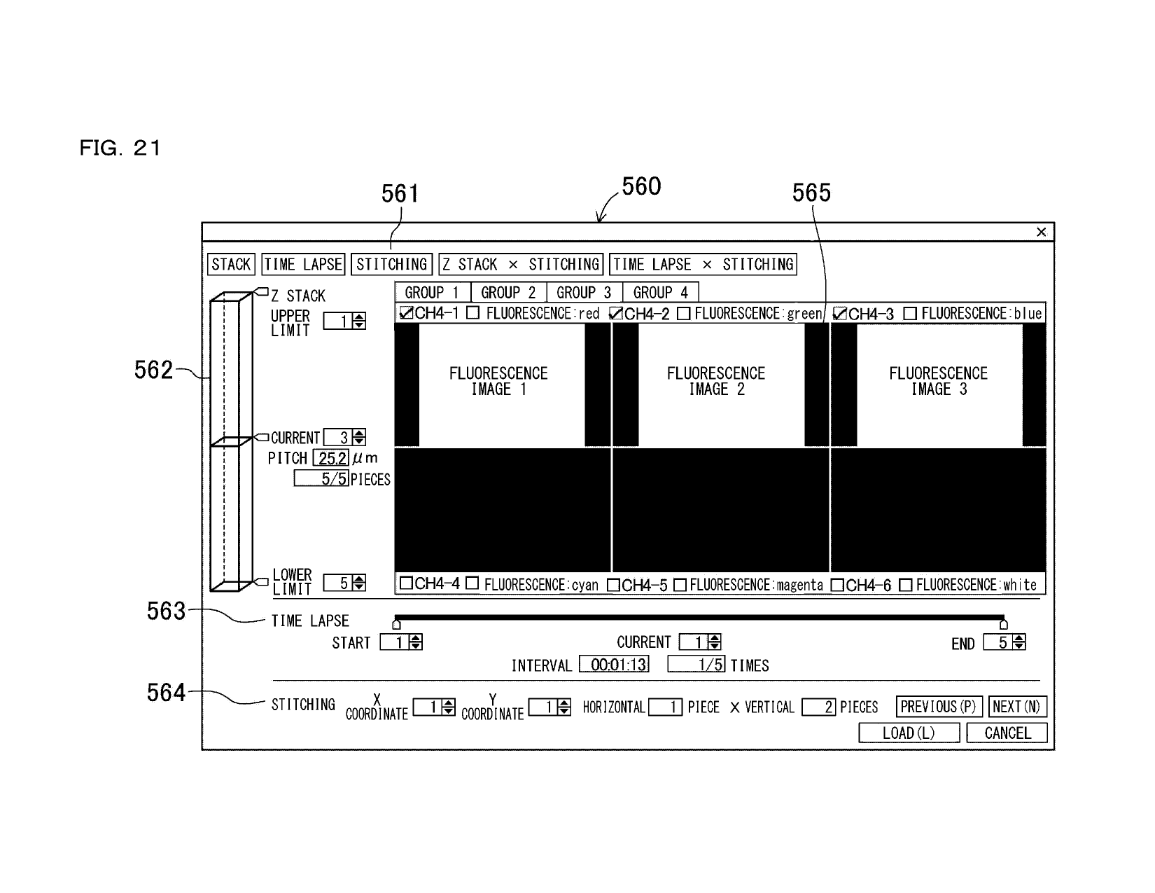

FIG. 21 illustrates a mode in which images (examples: fluorescence image 1, fluorescence image 2, fluorescence image 3) of a plurality of channels are displayed in the group image display region 565. In this display mode, display and non-display of each image can be switched, and images of the plurality of channels can be selected.

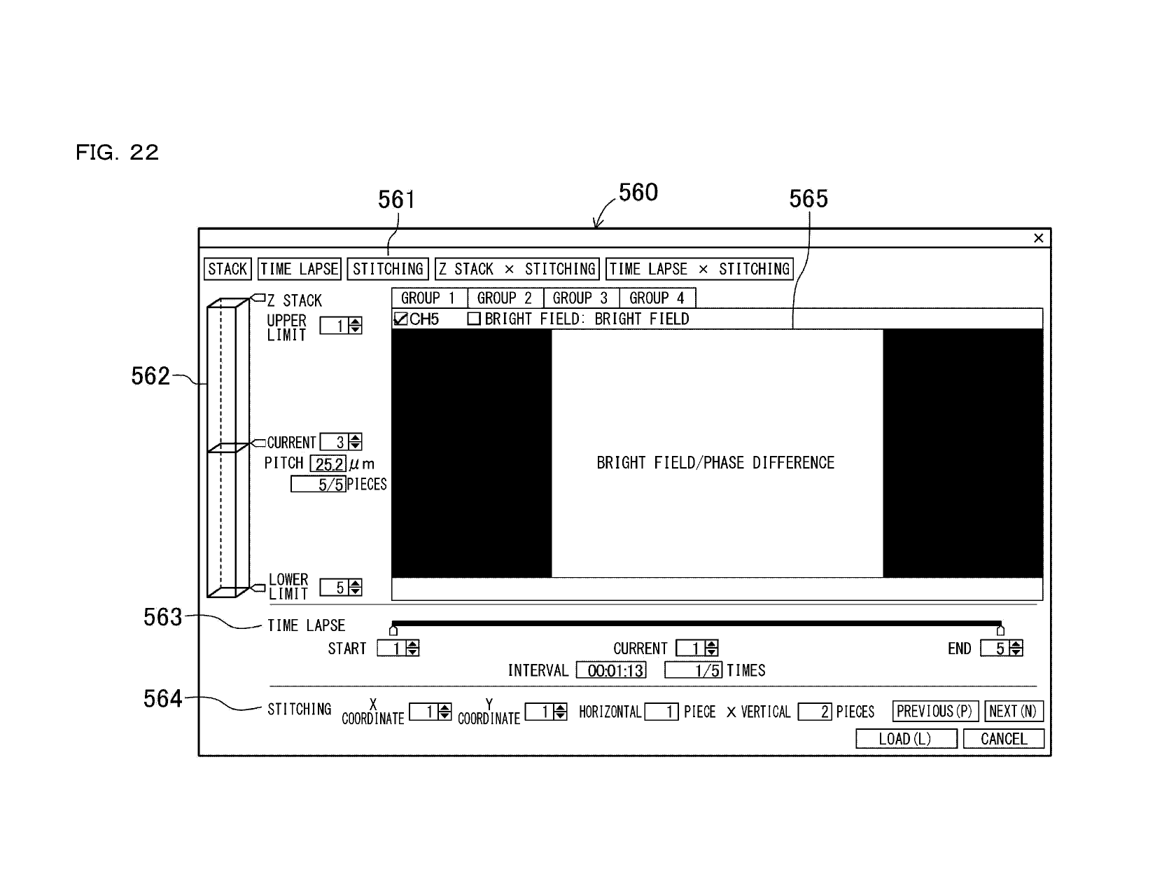

FIG. 22 illustrates a mode of displaying a bright field image and/or a phase difference image in the group image display region 565. In this display mode, images other than the fluorescence image such as a bright field image and a phase difference image can also be confirmed.

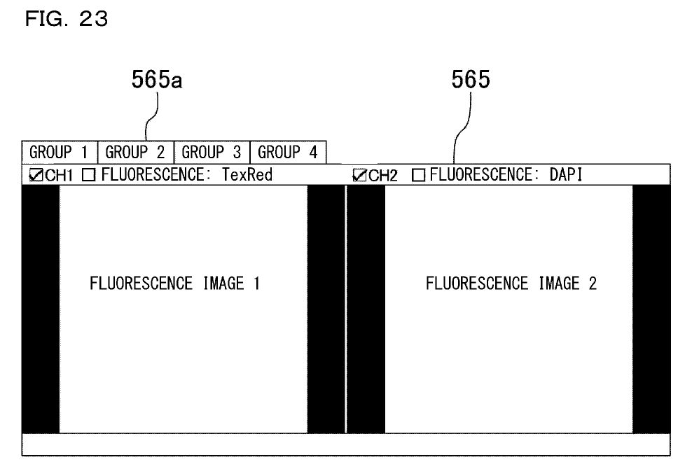

The display control section 60 can acquire the number-of-groups determined by the number-of-groups determination section 63 and switch display modes of images belonging to a predetermined group on the basis of the acquired number-of-groups. FIG. 23 illustrates another display example of images belonging to a predetermined group. In this display example, two fluorescence images are displayed side by side. A group selection region 565a is provided in the group image display region 565, and when the user performs an operation of selecting a desired group in the group selection region 565a, images belonging to the selected group are displayed in the group image display region 565. In the group selection region 565a, for example, selection by a tab provided for each group can be received. In a case where the number-of-groups is one, only images belonging to one group are displayed in the group image display region 565 illustrated in FIG. 23. As described above, in a case where the number-of-groups determined by the number-of-groups determination section 63 is one, the display control section 60 displays images belonging to the group on one screen. Furthermore, in a case where the number-of-groups determined by the number-of-groups determination section 63 is two or more, the display control section 60 enables switching display between images belonging to the first group and images belonging to the second group.

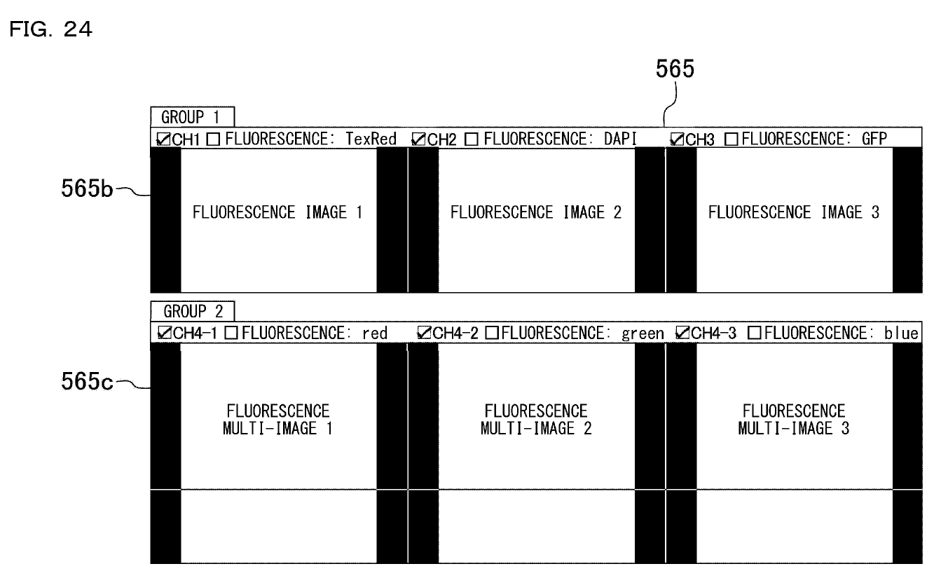

On the other hand, FIG. 24 illustrates a display example of images belonging to each group in a case where the number-of-groups is two or more. In this display example, the images of the two groups are displayed separately. A plurality of images belonging to “group 1” is displayed side by side in a first display region 565b, and a plurality of images belonging to “group 2” is displayed side by side in a second display region 565c. In a case where the number of images is large and all the images cannot be displayed on one screen, it is possible to confirm all the images by scrolling the screen vertically or horizontally.

In a case where the number-of-groups determined by the number-of-groups determination section 63 is one, the display control section 60 displays images belonging to one group on one screen, for example, as illustrated in FIG. 23. On the other hand, in a case where the number-of-groups determined by the number-of-groups determination section 63 is two or more, the display control section 60 displays images belonging to the first group and images belonging to the second group side by side in a predetermined direction. The images belonging to the first group and the images belonging to the second group may be displayed side by side in the horizontal direction or may be displayed side by side in the up and down direction.

As illustrated in these display examples, the display method of the images belonging to the predetermined group may be any method as long as the user can understand that the images belong to the predetermined group. Therefore, the convenience of the user at the time of observation is improved.

### Generation processing of stitched image

The stitching section 64 illustrated in FIG. 2 executes a process of stitching a plurality of images according to the image stitching setting to generate a stitched image. The stitching section 64 executes an alignment process of images to be stitched before executing the process of stitching a plurality of images. At the time of image stitching, since there is a portion not focused depending on the Z position in one image, the stitching may be difficult. In response to this, in the present embodiment, the following processing is executed: the focus value of the image stored in the group file is checked, the position having the highest focus value is acquired, the stitching is executed at the position having the highest focus value, and a stitching parameter (alignment information) obtained at the time of executing the stitching is applied to another Z position. That is, the stitching section 64 can execute the stitching of a plurality of images at a position in focus and apply the stitching parameter (alignment information) obtained at the time of executing the stitching to another Z position. Therefore, this enables accurate alignment even with a small amount of image information. Note that the same applies to a case where images captured at different times are stitched.

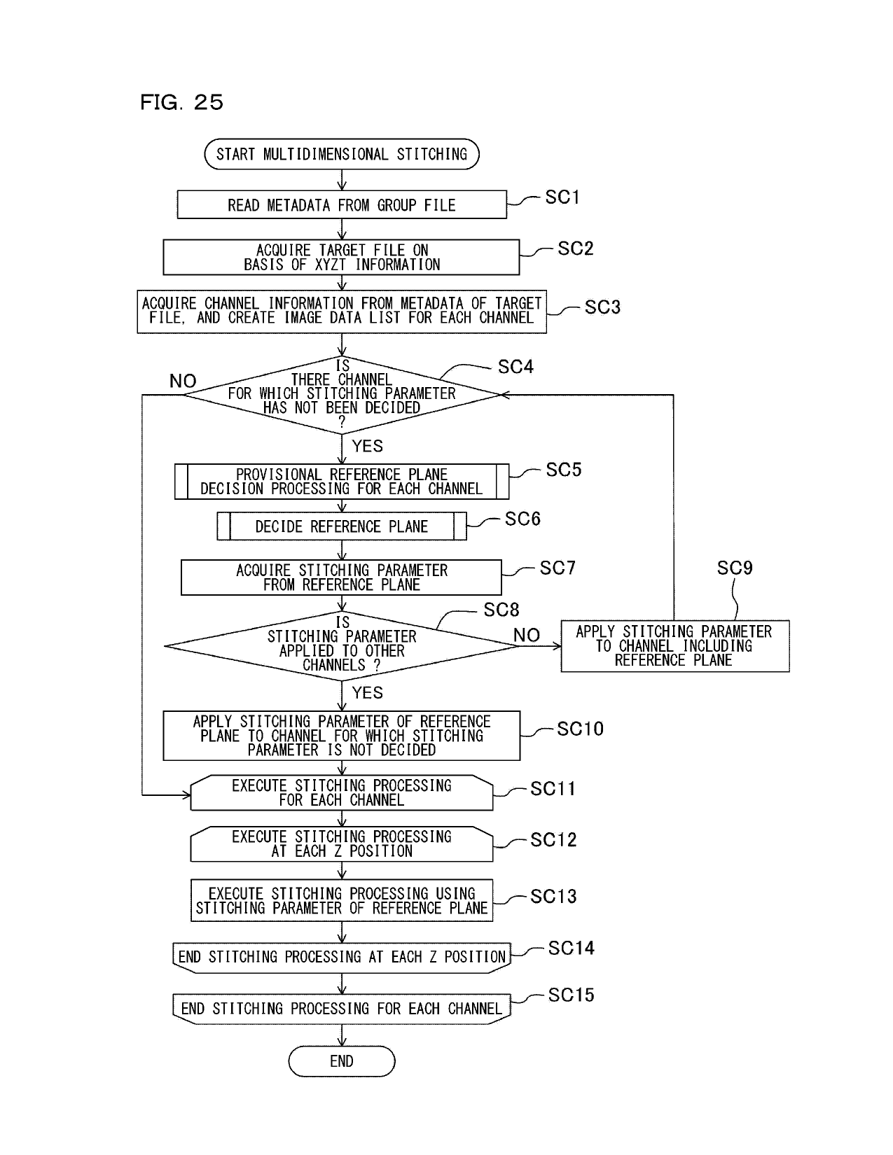

FIG. 25 is a flowchart illustrating a process of stitching a plurality of images. This flowchart can be started on the basis of an instruction from the user, and is executed by the stitching section 64. In step SC1, metadata is read from the group file stored in the storage section 70. For example, the images included in the first group include a plurality of pseudo color images belonging to the first channel and having different XY positions and Z positions. Each of the pseudo color images belonging to the first channel is associated with a focus value. Furthermore, the first group may further include a plurality of pseudo color images belonging to the second channel and having different XY positions and Z positions.

In step SC2, XYZT information (information about XY position, Z position, and time) included in the metadata acquired in step SC1 is acquired, and a target file is acquired on the basis of the acquired XYZT information.

In step SC3, channel information is acquired from the metadata of the target file acquired in step SC2, and an image data list for each channel is created. In step SC4, it is determined whether or not there is a channel for which a stitching parameter to be applied at the time of stitching images has not been decided. In a case where there is no channel for which the stitching parameter has not been decided, the process proceeds to step SC11. On the other hand, in a case where there is a channel for which the stitching parameter has not been decided, the process proceeds to step SC5.

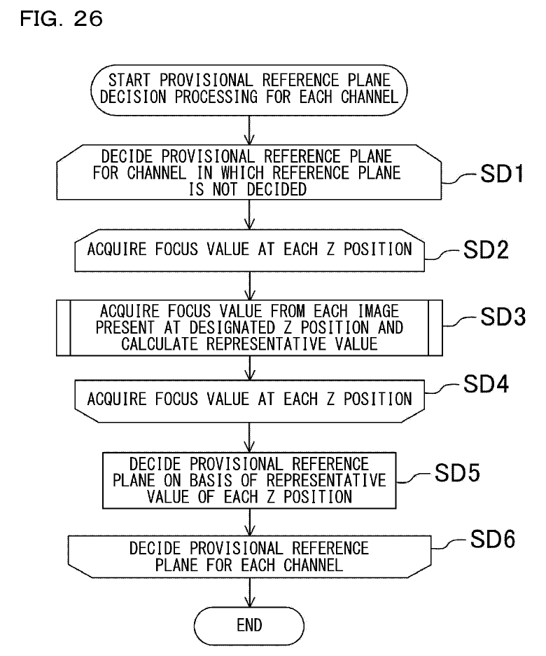

In step SC5, provisional reference plane decision processing for each channel is executed. FIG. 26 is a flowchart illustrating details of the provisional reference plane decision processing for each channel. In step SD1, a provisional reference plane is decided for a channel for which a reference plane is not decided. In step SD2, processing of acquiring the focus value at each Z position is started. In step SD3, each image present at the designated Z position is specified, a focus value of the specified image is acquired, and a representative value is calculated. In step SD4, the process of acquiring the focus value at each Z position is ended.

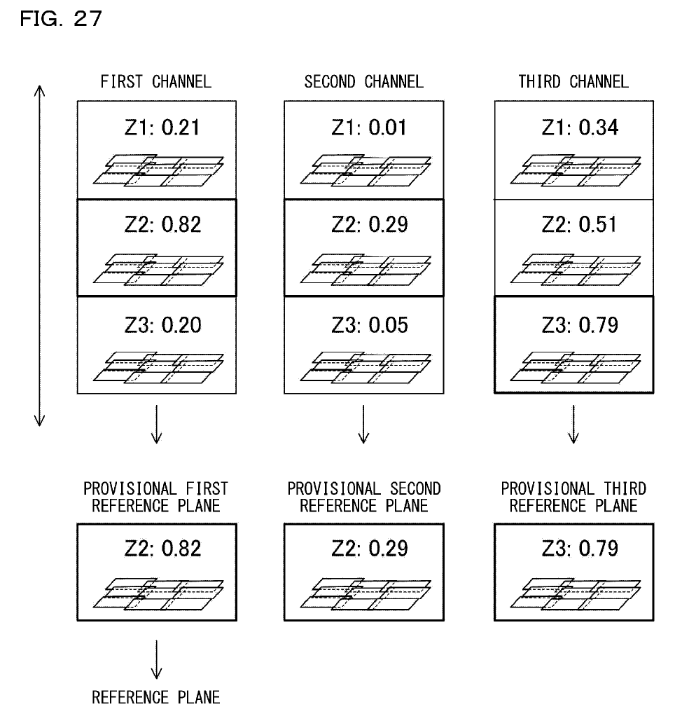

In step SD5, a provisional reference plane is decided on the basis of the representative value of each Z position. That is, for example, as illustrated in FIG. 27, in a case where the acquired target file includes images of the first channel, the second channel, and the third channel, Z2 of the first channel is set as a provisional first reference plane, Z2 of the second channel is set as a provisional second reference plane, and Z3 of the third channel is set as a provisional third reference plane on the basis of the representative value calculated in step SD3. In this manner, a provisional reference plane for each channel is decided in step SD6. Note that the number of provisional reference planes is not limited to three, and may be any number.

When step SD6 ends, a reference plane (reference Z height) is decided in step SC6 of FIG. 25. At this time, a plane having the best focus value among the provisional first reference plane, the provisional second reference plane, and the provisional third reference plane in FIG. 27 is set as a reference plane (reference Z height). In this example, since the focus value of the provisional first reference plane is better than the focus values of the provisional second reference plane and the provisional third reference plane, the provisional first reference plane is set as the reference plane. That is, the reference Z height that is the reference plane stitching the images is specified from among the plurality of pseudo color images belonging to the first channel.

In step SC7 of FIG. 25, the stitching parameter is acquired from the reference plane decided in step SC6. That is, at the reference Z height decided from among the plurality of pseudo color images belonging to the first channel, the reference stitching parameter of the images acquired at different XY positions is calculated. In step SC8, it is determined whether or not the reference stitching parameter is applied to another channel. In a case where the reference stitching parameter is not applied to another channel, the process proceeds to step SC9, the stitching parameter is also applied to a channel including the reference plane, and then the process proceeds to step SC4.

In a case where the reference stitching parameter is also applied to another channel, the process proceeds to step SC10, and the stitching parameter of the reference plane is applied to a channel for which the stitching parameter has not been decided. The stitching parameter obtained from the reference plane can also be applied to different Z positions of the same channel and can also be applied to each Z position of different channels. That is, on the basis of the reference stitching parameter calculated at the reference Z height specified from the plurality of pseudo color images belonging to the first channel, images acquired at different XY positions for each Z height of the second channel are stitched.

In step SC11, the stitching processing for each channel is started. In step SC12, the stitching processing is executed at each Z position. In step SC13, the stitching processing is executed using the reference stitching parameter of the reference plane. In step SC14, the stitching processing ends at each Z position. In step SC15, the stitching processing for each channel ends.

As described above, the stitching section 64 can specify the reference Z height for stitching a plurality of images acquired at different XY positions on the basis of the focus value. Then, the stitching section 64 can calculate stitching parameters of images acquired at different XY positions at the specified reference Z height, stitch images acquired at different XY positions at the reference Z height on the basis of the calculated stitching parameters, and stitch images acquired at different Z heights on the basis of the stitching parameters at the reference Z height. At this time, the stitching section 64 can also stitch images acquired at different XY positions for each Z height of the second channel and stitch images acquired at different XY positions for each Z height of the third channel on the basis of the stitching parameter.

The above-described embodiments are merely examples in all respects, and should not be construed in a limiting manner. Moreover, all modifications and changes falling within the equivalent scope of the claims are within the scope of the present invention.

As described above, the fluorescence microscope according to the present disclosure can be used, for example, in the case of observing a biological specimen or the like.

What is claimed is:

1. A fluorescence microscope comprising:
a stage on which an observation target is placed;
an excitation light source configured to irradiate the observation target placed on the stage with excitation light;
an illumination light source configured to irradiate the observation target placed on the stage with illumination light;
a plurality of absorption filters each configured to transmit a different wavelength band of fluorescence generated in the observation target irradiated with the excitation light by the excitation light source;
a turret in which the plurality of absorption filters is disposed, and configured to switch one absorption filter disposed on an observation optical path;
a turret control section configured to sequentially switch, by the turret, one absorption filter disposed on the observation optical path;
a detection section configured to sequentially detect fluorescence transmitted through one absorption filter disposed on the observation optical path by a switching operation of the turret controlled by the turret control section, and detect transmission light of the observation target irradiated with illumination light by the illumination light source;
an image processing section configured to generate a plurality of pseudo color images on a basis of fluorescence sequentially detected by the detection section and a wavelength band of the absorption filter disposed on the observation optical path and generate a non-fluorescence image on a basis of the transmission light detected by the detection section;
a group image generation section configured to set the plurality of pseudo color images generated by the image processing section as images belonging to a first group and set the non-fluorescence image generated by the image processing section as images belonging to a second group;
a storage section configured to store the images belonging to the first group and the images belonging to the second group;
a specification section configured to specify a predetermined group among a plurality of groups stored in the storage section; and
a display control section configured to cause a display section to display images belonging to the predetermined group specified by the specification section.

2. The fluorescence microscope according to claim 1, wherein
a multi-dichroic mirror configured to transmit fluorescence in a plurality of wavelength bands is further disposed in the turret,
the fluorescence microscope further comprising a plurality of emission filters configured to transmit a different wavelength band of fluorescence transmitted through the multi-dichroic mirror,
wherein
a wavelength band of the fluorescence detected by the detection section is sequentially switched by sequentially switching the emission filters in a state where the multi-dichroic mirror is disposed on the observation optical path by the turret controlled by the turret control section,
the group image generation section sets, as images belonging to the first group, the plurality of pseudo color images generated on a basis of the fluorescence transmitted through the absorption filter among the plurality of pseudo color images generated by the image processing section, and sets, as images belonging to a third group, a plurality of pseudo color images generated on a basis of fluorescence transmitted through the multi-dichroic mirror and the emission filters, and
the storage section further stores the images belonging to the third group.

3. The fluorescence microscope according to claim 1, wherein
a multi-dichroic mirror configured to transmit fluorescence in a plurality of wavelength bands is further disposed in the turret,
the fluorescence microscope further comprising a plurality of emission filters configured to transmit a different wavelength band of fluorescence transmitted through the multi-dichroic mirror,
wherein
a wavelength band of the fluorescence detected by the detection section is sequentially switched by sequentially switching the emission filters in a state where the multi-dichroic mirror is disposed on the observation optical path by the turret controlled by the turret control section, and
the group image generation section sets, as images belonging to the first group, the plurality of pseudo color images generated on a basis of the fluorescence transmitted through the absorption filter and a plurality of pseudo color images generated on a basis of fluorescence transmitted through the multi-dichroic mirror and the emission filters.

4. The fluorescence microscope according to claim 2, wherein
the plurality of pseudo color images generated on a basis of the fluorescence transmitted through the absorption filter are high brightness fluorescence images, and
the pseudo color images generated on a basis of the fluorescence transmitted through the multi-dichroic mirror and the emission filters are low brightness fluorescence images.

5. The fluorescence microscope according to claim 2, wherein
the plurality of pseudo color images generated on a basis of the fluorescence transmitted through the absorption filter are low-speed captured fluorescence images, and
the pseudo color images generated on a basis of the fluorescence transmitted through the multi-dichroic mirror and the emission filters are high-speed captured fluorescence images.

6. The fluorescence microscope according to claim 1, wherein the display control section causes the display section to display a setting user interface screen that receives a setting of fluorescence observation and a setting of a display color as an observation method for each observation channel corresponding to the absorption filter disposed on the observation optical path.

7. The fluorescence microscope according to claim 6, wherein
the setting user interface screen is configured to be able to receive a setting of fluorescence multi-observation as an observation channel, and
a plurality of subchannels corresponding to the observation channel of the fluorescence multi-observation is displayed on the setting user interface screen, and a display color is configured to be able to be set for each subchannel.

8. The fluorescence microscope according to claim 7, wherein the setting user interface screen receives a setting of non-fluorescence observation as an observation method.

9. The fluorescence microscope according to claim 8, wherein the group image generation section groups pseudo color images or non-fluorescence images for each observation method of which setting is received on the setting user interface screen.

10. The fluorescence microscope according to claim 1, wherein the detection section includes a first detection section configured to sequentially detect fluorescence transmitted through one absorption filter disposed on the observation optical path by the turret control section, and a second detection section configured to detect transmission light of the observation target irradiated with illumination light by the illumination light source.

11. The fluorescence microscope according to claim 1, wherein
the image processing section generates both a phase difference image and a bright field image as non-fluorescence images,
the group image generation section sets the phase difference image as an image belonging to the second group and sets the bright field image as an image belonging to a fourth group, and
the storage section further stores the image belonging to the fourth group.

12. The fluorescence microscope according to claim 1, further comprising a number-of-groups determination section configured to determine a number-of-groups of groups stored in the storage section,
wherein
the image processing section associates observation channels with each of the pseudo color images and the non-fluorescence image,
the number-of-groups determination section determines the number-of-groups on a basis of a unique number of the observation channels associated with the pseudo color images or the non-fluorescence image generated by the image processing section, and
the display control section switches a display mode of images belonging to the groups on a basis of the number-of-groups determined by the number-of-groups determination section.

13. The fluorescence microscope according to claim 12, wherein in a case where the number-of-groups determined by the number-of-groups determination section is one, the display control section causes the images belonging to the group to be displayed on one screen, and in a case where the number-of-groups determined by the number-of-groups determination section is two or more, the display control section enables switching display between the images belonging to the first group and the images belonging to the second group.

14. The fluorescence microscope according to claim 12, wherein in a case where the number-of-groups determined by the number-of-groups determination section is one, the display control section causes the images belonging to the group to be displayed on one screen, and in a case where the number-of-groups determined by the number-of-groups determination section is two or more, the display control section causes the images belonging to the first group and the images belonging to the second group to be displayed side by side.

15. The fluorescence microscope according to claim 1, wherein
the plurality of pseudo color images belonging to the first group includes a plurality of images acquired at positions having different Z heights and a plurality of images acquired at different XY positions, and
the non-fluorescence image belonging to the second group includes a plurality of images acquired at positions having different Z heights and a plurality of images acquired at different XY positions.

16. The fluorescence microscope according to claim 15, wherein
the first group includes a plurality of pseudo color images belonging to a first channel and having different XY positions and Z positions, and a focus value is associated with each of the pseudo color images belonging to the first channel,
the fluorescence microscope further comprising a stitching section configured to specify a reference Z height for stitching a plurality of images acquired at different XY positions on a basis of the focus value from among the plurality of pseudo color images belonging to the first channel, calculate reference stitching parameters of images acquired at different XY positions at the reference Z height, stitch images acquired at different XY positions at the reference Z height on a basis of the calculated reference stitching parameters, and, for each of other Z heights, stitches images acquired at different XY positions based on the reference stitching parameters.

17. The fluorescence microscope according to claim 16, wherein
the first group further includes a plurality of pseudo color images belonging to a second channel and having different XY positions and Z positions, and
the stitching section stitches images acquired at different XY positions for each Z height of the second channel on a basis of the reference stitching parameter calculated at the reference Z height specified from among the plurality of pseudo color images belonging to the first channel.

18. The fluorescence microscope according to claim 1, wherein
the plurality of pseudo color images belonging to the first group includes a plurality of images acquired at different times, and
the non-fluorescence image belonging to the second group includes a plurality of images acquired at different times.

19. The fluorescence microscope according to claim 18, further comprising a determination section configured to determine whether or not the plurality of pseudo color images included in the first group has been acquired over time at different times,
wherein the display control section causes the display section to display a time change icon in a case where the determination section determines that the plurality of pseudo color images included in the first group has been acquired chronologically over time at different times.

20. The fluorescence microscope according to claim 15, further comprising a determination section configured to determine whether or not the plurality of pseudo color images included in the first group has been acquired at different Z heights,
wherein the display control section causes the display section to display a height change icon in a case where the determination section determines that the plurality of pseudo color images included in the first group has been acquired at different Z heights.
